(19) United States
(12) Patent Application Publication
(10) Pub. No.: US 2026/0162117 A1
(43) Pub. Date: Jun. 11, 2026

(54) SYSTEMS AND METHODS IMPLEMENTING DECENTRALIZED PAYMENT PROCESSING AT EDGE DEVICE OF PAYMENT PROCESSING NETWORK

(71) Applicant: Capital One Services, LLC, McLean, VA (US)

(72) Inventors: Jeffrey Rule, Chevy Chase, MD (US); Jeffrey Carlyle Wieker, Falls Church, VA (US); Jackson Macomber, Henrico, VA (US)

(73) Assignee: Capital One Services, LLC, McLean, VA (US)

(21) Appl. No.: 18/971,127

(22) Filed: Dec. 6, 2024

(51) Int. Cl. G06Q 20/40; G06Q 20/42

(52) U.S. Cl. CPC G06Q 20/4016; G06Q 20/4018; G06Q 20/42

(57) ABSTRACT

An exemplary payment gateway device includes a processor and a memory. The processor is configured to: receive, from a server, merchant specific data associated with a user; validate card data of a card of the user based on the merchant specific data; perform, using a machine learning model, an analysis on a transaction being conducted using the card by the user with a merchant associated with the payment gateway device, the analysis including comparing a transaction size of the transaction, a frequency of the transaction, a location of the transaction, a time of the transaction, and a merchant type of the merchant, against a known behavior pattern of the user; determine, based on the analysis, whether the transaction is a fraud transaction; in responsive to a determination that the transaction is a legitimate transaction, verify an account balance and fund availability of the card; and approve the transaction.

### BACKGROUND

Cards, such as credit cards, have become ubiquitous in completing transactions over the Internet or in stores. To complete a transaction, the transaction data including card data of a card used for the transaction is transmitted through a payment processing network to a bank server for processing and approving/denying the transaction. The bank server is associated with a bank issuing the card. On one hand, this would increase the workload of the bank server, and on the other hand, this would delay the transaction processing, which may impact user's shopping experience.

These and other deficiencies exist. As such, there is a need for an improved system and method for processing card transactions that promotes user convenience and reduces the burden of a bank server.

### SUMMARY OF THE INVENTION

Aspects of the present application include systems and methods implementing decentralized payment processing at an edge device of the payment processing network.

In one aspect, a payment gateway system for decentralized payment processing is provided. In some embodiments, the payment gateway system includes a payment gateway device. The payment gateway device includes a processor, and a memory storing computer-executable instructions. When the computer-executable instructions are executed by the processor, the computer-executable instructions can cause the processor to: receive, from a server, merchant specific data associated with a user; validate card data of a card of the user based on the merchant specific data; perform, using a machine learning model, an analysis on a transaction being conducted using the card by the user with a merchant associated with the payment gateway device, the analysis including comparing a transaction size of the transaction, a frequency of the transaction, a location of the transaction, a time of the transaction, and a merchant type of the merchant, against a known behavior pattern of the user; determine, based on the analysis, whether the transaction is a fraud transaction; in responsive to a determination that the transaction is a legitimate transaction, verify an account balance and fund availability of the card; and approve the transaction.

In another aspect, a method for decentralized payment processing is provided. In some embodiments, the method includes receiving, by a payment gateway from a server, merchant specific data associated with a user; validating, by the payment gateway, card data of a card of the user based on the merchant specific data; performing, by the payment gateway using a machine learning model, an analysis on a transaction being conducted using the card by the user with the merchant; determining, by the payment gateway based on the analysis, whether the transaction is a fraud transaction; verifying, by the payment gateway, an account balance and fund availability of the card; and approving, by the payment gateway, the transaction.

In yet another aspect, a non-transitory computer-readable storage medium for decentralized payment processing is provided. The non-transitory computer-readable storage medium includes executable instructions stored thereon, which when executed by a payment gateway device of a payment gateway system, cause the payment gateway device to perform various operations. For example, in some embodiments, the payment gateway device is caused to: receive, from a server, merchant specific data associated with a user; validate card data of a card of the user based on the merchant specific data; perform, using a machine learning model, an analysis on a transaction being conducted using the card by the user with a merchant associated with the payment gateway device; determine, based on the analysis, whether the transaction is a fraud transaction; verify an account balance and fund availability of the card; and approve the transaction.

Non-transitory computer program products (e.g., physically embodied computer program products) are also described that store instructions, which, when executed by one or more data processors (e.g., processor circuit) of one or more computing systems, cause at least one data processor to perform one or more of the operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 is a network diagram of an example system for decentralized payment processing in accordance with embodiments discussed herein.

FIG. 2 illustrates an example sequence flow of the system in FIG. 1 in accordance with embodiments discussed herein.

FIG. 3 illustrates a flow chart of an example method of decentralized payment processing in accordance with embodiments discussed herein.

FIG. 4 is a network diagram of an example system for decentralized payment processing in accordance with embodiments discussed herein.

FIG. 5 illustrates an example sequence flow of the system in FIG. 4 in accordance with embodiments discussed herein.

FIG. 6 illustrates a flow chart of an example method of decentralized payment processing in accordance with embodiments discussed herein.

FIG. 7 illustrates a block diagram of an example payment gateway system configured to operate in accordance with embodiments discussed herein.

FIG. 8 illustrates a block diagram of an example machine learning model configured to operate in accordance with embodiments discussed herein.

FIG. 9 illustrates a flow chart of an example machine learning analysis of decentralized payment processing in accordance with embodiments discussed herein.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Described herein are exemplary systems and methods for decentralized payment processing at the edge of the payment processing network for, for example, vertically integrated banks. In some embodiments, if an issuing bank were to achieve true vertical integration from the payment gateway to the issuing bank, the issuing bank can decentralize decisions such as card approval, fraud check, sufficient funds check, to an edge device (e.g., a payment gateway system) of the payment processing network and make the edge device specific/personalized to a merchant. In such a fully vertically integrated payment processing network, the issuing bank can allow for a significant workload shift towards decentralization and real-time processing capabilities.

In the disclosed decentralized payment processing system and method, user data can be pushed to the edge device/system of the payment processing network. For example, the edge system can comprise a payment gateway device, which is the first system having data interaction with a user and can takes on a much larger role. The payment gateway system can be associated with a merchant and is configured to receive merchant specific data. For example, data on card approval, fraud and sufficient funds checks can be pushed to the edge device of the payment processing network. This data can be tailored to the merchant. In some embodiments, only users that have had previous transactions at the merchant would have their data pushed. This can significantly speed transactions for recurring users. Herein, the recurring users can refer to users who had at least one previous transaction with the merchant. In some embodiments, new users who have a transaction with the merchant for the first time may follow a more traditional transaction processing model where the issuing bank can perform the fraud and sufficient fund checks and approve the transaction.

In the disclosed system and method, the payment gateway device/system can be configured to perform initial pre-authorization checks by validating the card details (such as card number, expiration date, and card verification value (CVV)) and ensuring they match a real and active account associated with the card. This step can reduce the number of fraudulent attempts that normally occur deeper into the payment processing network. In some embodiment, for fraud detection at the payment gateway system, machine learning models can be implemented at the payment gateway system to analyze transactions in real-time for patterns indicative of fraud. This analysis can include factors like transaction size, transaction frequency, transaction location, and merchant type. This analysis can compare these factors against known user behavior patterns.

In some embodiments, transaction data and card data can be stored in a distributed ledger, which is a secure way for distributing this information. The distributed ledger can be a blockchain. The blockchain or distributed ledger technology can be used to maintain a secure, real-time ledger of card account balances and transactions. This can allow for immediate verification of card funds availability and transaction legitimacy at any point in the payment processing network, significantly reducing the time needed for fund verification.

In some embodiment, advanced machine learning models are applied on the edge device of the payment processing network for merchant specific fraud checks. These machine learning models can be deployed on edge devices or in localized data centers closer to the transaction origin. These models can quickly assess transactions for fraud risk based on real-time data, historical patterns, and predictive analytics without the need to query central databases extensively that can be associated with a backend bank server.

In some embodiments, a user can receive instant alerts for transactions requiring additional verification and/or approval of the transactions. These alerts can even be sent before the transaction is complete, allowing users to block a fraudulent transaction before it takes place. Users can approve or deny transactions through a mobile application installed on a user device of the user, adding an extra layer of security and reducing the incidence of false declines.

In some embodiments, a user may identify himself with a merchant through credentials associated with a merchant account of the user and/or a contactless card. Upon authenticating the user at the merchant side (e.g., payment gateway side), the bank server associated with the user can communicate back to the payment gateway authorizing the user to make purchases from the merchant. Then the user can make a purchase from the merchant almost immediately without having to communicate directly to the authorizing bank (i.e., the bank server). For example, when a user verifies his identity on a merchant's website using a contactless card, the website can make a call to the bank server that will store card information of the user on the gateway device. The user can be automatically approved without having the transaction go back to the issuing bank (i.e., the bank server).

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, desirable, or even possible in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

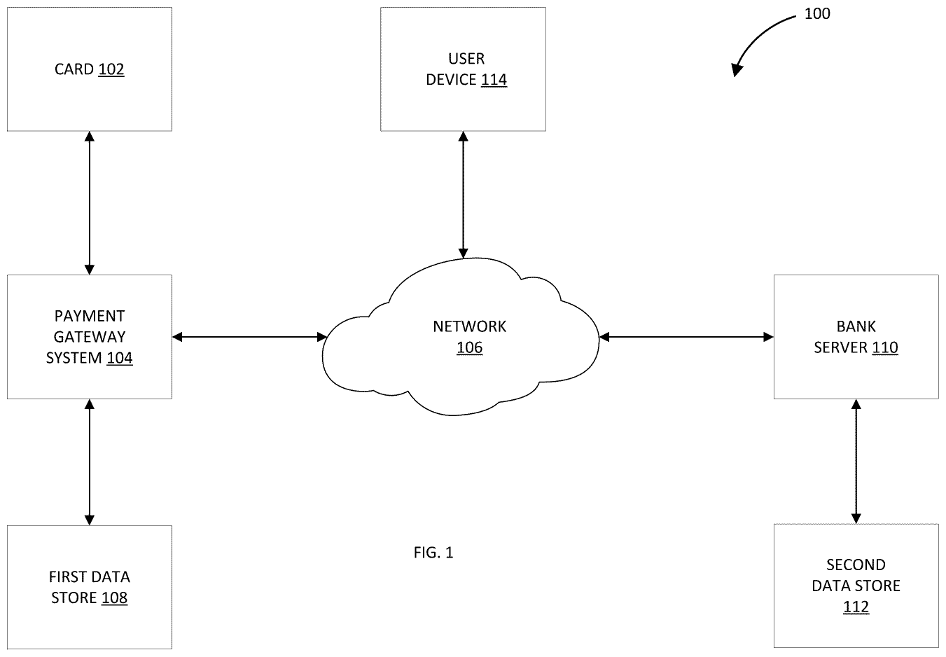

FIG. 1 illustrates system 100 for providing decentralized payment processing at the edge of the payment processing network according to an example embodiment. As further discussed below, system 100 may include card 102, payment gateway system 104, network 106, first data store 108, bank server 110, second data store 112, and user device 114. Although FIG. 1 illustrates single instances of the components, system 100 may include any number of components.

System 100 may include one or more cards 102. In some embodiments, card 102 may be in wireless communication, utilizing near field communication (NFC) in an example, with payment gateway system 104 and user device 114. As described below, card 102 may provide one factor of authentication to authenticate an identity of the user of the payment gateway system 104.

In some embodiment, card 102 may include a contactless card, a payment card, such as a credit card, debit card, or gift card, issued by a service provider as displayed as service provider indicia on the front or back of card 102. The service provider may be a financial institution, such as a bank that is associated with Bank server 110. In some examples, card 102 is not related to a payment card, and may include, without limitation, an identification card. In some examples, card 102 may include a dual interface contactless payment card, a rewards card, and so forth. Card 102 may include a substrate, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, card 102 may have physical characteristics compliant with the ID-1 format of the ISO/IEC 7816 standard, and may otherwise be compliant with the ISO/IEC 14443 standard. However, it is understood that card 102 according to the present disclosure may have different characteristics, and the present disclosure does not require card 102 to be implemented in a payment card.

Card 102 may also include identification information displayed on the front and/or back of card 102, and a contact pad. The contact pad may include one or more pads and be configured to establish contact with another device, such as an automated teller machine (ATM), user device 114, smartphone, laptop, desktop, or tablet computer. The contact pad may be designed in accordance with one or more standards, such as ISO/IEC 7816 standard, and enable communication in accordance with the EMV protocol. Card 102 may also include processing circuitry, antenna and other components. These components may be located behind the contact pad or elsewhere on the substrate, e.g. within a different layer of the substrate, and may electrically and physically coupled with the contact pad. Card 102 may also include a magnetic strip or tape, which may be located on the back of card 102. Card 102 may also include a Near-Field Communication (NFC) device coupled with an antenna capable of communicating via the NFC protocol. Embodiments are not limited in this manner. The contact pad of card 102 may include processing circuitry for storing, processing, and communicating information, including a processor, a memory, and one or more interface(s). It is understood that the processing circuitry may contain additional components, including processors, memories, error and parity/CRC checkers, data encoders, anticollision algorithms, controllers, command decoders, security primitives and tamperproofing hardware, as necessary to perform the functions described herein.

The memory of the contact pad may be a read-only memory, write-once read-multiple memory or read/write memory, e.g., RAM, ROM, and EEPROM, and card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory may be encrypted memory utilizing an encryption algorithm executed by the processor to encrypted data.

The memory of the contact pad may be configured to store one or more applet(s), one or more counter(s), a customer identifier, and an account number(s), which may be virtual account numbers. The one or more applet(s) may comprise one or more software applications configured to execute on one or more contactless cards, such as a Java® Card applet. However, it is understood that applet(s) are not limited to Java Card applets, and instead may be any software application operable on contactless cards or other devices having limited memory. The one or more counter(s) may comprise a numeric counter sufficient to store an integer. The customer identifier may comprise a unique alphanumeric identifier assigned to a user of card 102, and the identifier may distinguish the user of card 102 from other contactless card users. In some examples, the customer identifier may identify both a customer and an account assigned to that customer and may further identify card 102 associated with the customer's account. As stated, the account number(s) may include thousands of one-time use virtual account numbers associated with card 102. An applet(s) of card 102 may be configured to manage the account number(s) (e.g., to select an account number(s), mark the selected account number(s) as used, and transmit the account number(s) to user device 114 or payment gateway system 104 for autofilling by an autofilling service.

In some examples, card 102 may comprise one or more antenna(s). The one or more antenna(s) may be placed within card 102 and around the processing circuitry of the contact pad. For example, the one or more antenna(s) may be integral with the processing circuitry and the one or more antenna(s) may be used with an external booster coil. As another example, the one or more antenna(s) may be external to the contact pad and the processing circuitry.

In an embodiment, coil of card 102 may act as the secondary of an air core transformer. A terminal, such as user device 114 or payment gateway system 104 may communicate with card 102 by cutting power or amplitude modulation. Card 102 may infer the data transmitted from the terminal using the gaps in the contactless card's power connection, which may be functionally maintained through one or more capacitors. Card 102 may communicate back by switching a load on the contactless card's coil or load modulation. Load modulation may be detected in the terminal's coil through interference. More generally, using the antenna(s), processor, and/or the memory, card 102 provides a communications interface to communicate via NFC, Bluetooth, and/or Wi-Fi communications.

As explained above, card 102 may be built on a software platform operable on smart cards or other devices having limited memory, such as JavaCard, and one or more or more applications or applets may be securely executed. Applet(s) may be added to contactless cards to provide a one-time password (OTP) for multifactor authentication (MFA) in various mobile application-based use cases. Applet(s) may be configured to respond to one or more requests, such as near field data exchange requests, from a reader, such as a mobile NFC reader (e.g., of User device 114 or point-of-sale terminal such as payment gateway system 104), and produce an NFC Data Exchange Format (NDEF) message that comprises a cryptographically secure OTP encoded as an NDEF text tag.

One example of an NDEF OTP is an NDEF short-record layout (SR=1). In such an example, one or more applet(s) may be configured to encode the OTP as an NDEF type 4 well known type text tag. In some examples, NDEF messages may comprise one or more records. The applet(s) may be configured to add one or more static tag records in addition to the OTP record.

In some examples, the one or more applet(s) may be configured to emulate a radio frequency identification (RFID) tag. The RFID tag may include one or more polymorphic tags. In some examples, each time the tag is read, different cryptographic data is presented that may indicate the authenticity of the contactless card. Based on the one or more applet(s), an NFC read of the tag may be processed, the data may be transmitted to a server, such as bank server 110 of a banking system, and the data may be validated at the server.

In some examples, card 102 may include certain data such that card 102 may be properly identified. Each time a read operation takes place, the counter(s) may be configured to increment. In some examples, each time data from card 102 is read (e.g., by user device 114), the counter(s) is transmitted to bank server 110 for validation and determines whether the counter(s) are equal (as part of the validation) to a counter of bank server 110.

The one or more counter(s) may be configured to prevent a replay attack. For example, if a cryptogram has been obtained and replayed, that cryptogram is immediately rejected if the counter(s) has been read or used or otherwise passed over. If the counter(s) has not been used, it may be replayed.

In some examples, the counter(s) may get out of sync. In some examples, to account for accidental reads that initiate transactions, such as reading at an angle, the counter(s) may increment but the application on user device 114 or payment gateway system 104 does not process the counter(s). In some examples, when payment gateway system 104 is woken up, NFC may be enabled and payment gateway system 104 may be configured to read available tags, but no action is taken responsive to the reads.

To keep the counter(s) in sync, an application, such as a background application, may be executed that would be configured to detect when payment gateway system 104 wakes up and synchronize with bank server 110 of a banking system indicating that a read that occurred due to detection to then move the counter(s) forward. In other examples, Hashed One Time Password may be utilized such that a window of mis-synchronization may be accepted. For example, if within a threshold of 10, the counter(s) may be configured to move forward. But if within a different threshold number, for example within 10 or 1000, a request for performing re-synchronization may be processed which requests via one or more applications that the user tap, gesture, or otherwise indicate one or more times via user device 114. If the counter(s) increases in the appropriate sequence, then it possible to know that the user has done so.

The key diversification technique described herein with reference to the counter(s), master key, and diversified key, is one example of encryption and/or decryption. This example key diversification technique should not be considered limiting of the disclosure, as the disclosure is equally applicable to other types of key diversification techniques.

During the creation process of card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time card 102 is used in operation, a different key may be used for creating a message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the counter increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

System 100 may include payment gateway system 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. payment gateway system 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Payment gateway system 104 can include a processor and a memory, and it is understood that the processor may contain additional components, including processors, memories, error and parity/CRC checkers, data encoders, anticollision algorithms, controllers, command decoders, security primitives and tamperproofing hardware, as necessary to perform the functions described herein. Payment gateway system 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, payment gateway system 104 may execute one or more applications, such as software applications, that enable, for example, network communications with one or more components of system 100 and transmit and/or receive data.

Payment gateway system 104 may be in communication with one or more servers/devices such as first data store 108, bank server 110, and/or user device 114 via one or more network(s) 106, and may operate as a respective front-end to back-end pair with any of those servers/devices. Payment gateway system 104 may transmit, for example from a software application (e.g., a browser) executing on payment gateway system 104, one or more requests to first data store 108. The one or more requests may be associated with retrieving data from first data store 108. First data store 108 may receive the one or more requests from payment gateway system 104. Based on the one or more requests from payment gateway system 104, first data store 108 may be configured to retrieve the requested data. First data store 108 may be configured to transmit the retrieved data to payment gateway system 104, the retrieved data being responsive to the one or more requests. This may include loading transaction history, user behavior pattern data, and fraud-related data from first data store 108.radio frequency identification.

In some embodiments, payment gateway system 104 can include a service that allows businesses to accept, process, and manage payments from customers. It acts as an intermediary between a merchant and their bank or processor to securely transfer funds from the customer's payment method to the merchant. Payment gateway system 104 can be used for in-person, online, or in-app payments, and can accept various payment methods, including credit cards, debit cards, and digital wallets. Payment gateway system 104 can also use encryption tools and safety protocols to ensure secure transactions, such as Transport Layer Security (TLS) or Secure Sockets Layer (SSL) certificates, Payment Card Industry Data Security Standard (PCI DSS) compliance, and fraud prevention tools like Address Verification Service (AVS) and/or Card Verification Value (CVV).

System 100 may include one or more networks 106. In some examples, network 106 may be one or more of a wireless network, a wired network or any combination of wireless network and wired network, and may be configured to connect payment gateway system 104 to bank server 110, and user device 114. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more first data store 108. First data store 108 can store user's transaction history, personal identifying information of users, user's purchase behavior patterns, fraud data, and so on. First data store 108 can be a database. The database may comprise a relational database, a non-relational database, or other database implementations, and any combination thereof, including a plurality of relational databases and non-relational databases. In some examples, first data store 108 may comprise a desktop database, a mobile database, or an in-memory database. Further, first data store 108 may be hosted internally by payment gateway system 104, or first data store 108 may be hosted externally to any component of system 100, such as by a cloud-based platform, or in any storage device that is in data communication with payment gateway system 104. In some examples, first data store 108 may be in data communication with any number of components of system 100.

System 100 may include bank server 110. Bank server 110 may include a memory and one or more processors, which are coupled to the memory. Bank server 110 may be configured to transmit user card data to payment gateway system 104 to allow payment gateway system 104 for authorizing transactions. Bank server 110 may be a server controlled by a financial institution. Bank server 110 may host a banking application which payment gateway system 104 and user device 114 can download, and payment gateway system 104 and bank server 110 can operates as a frontend to backend pair for the banking application.

Bank server 110 can host a bank application backend. When the user uses a mobile bank application on payment gateway system 104 or user device 114, the data populated on the mobile bank application can be pulled from bank server 110 for display. In some embodiments, bank server 110 can include a browser cookie generator. In some embodiments, the browser cookie generator can generate the temporary browser data file (e.g., the HTTP cookie). This unique HTTP cookie generated on enrolled devices creates device binding/trust for the user. Users who enroll after logging in with their bank credentials in the browser can create a device HTTP cookie.

Second data store 112 can be a database hosted on a server. The database may comprise a relational database, a non-relational database, or other database implementations, and any combination thereof, including a plurality of relational databases and non-relational databases. In some examples, second data store 112 may comprise a desktop database, a mobile database, or an in-memory database. Further, second data store 112 may be hosted internally by bank server 110, or second data store 112 may be hosted externally to any component of system 100, such as by a cloud-based platform, or in any storage device that is in data communication with bank server 110. In some examples, second data store 112 may be in data communication with any number of components of system 100. Second data store 112 can operate to provide authentication services for the user. For example, in some embodiments, second data store 112 can receive and decrypt encrypted data from card 102 to act as a validation system of the identity of the user of payment gateway system 104 and user device 114. Second data store 112 can therefore provide a factor of authentication for the system described herein. Second data store 112 can store user's bank account information, information of card 102 such as real card number, virtual card number, expiration date, card verification value (CVV), mailing and billing addresses of the user, transaction data history, account balance, available fund, and so forth. Bank server 110 can communicate such information to payment gateway system 104 to allow payment gateway system 104 to authorize or deny transactions of the user.

System 100 may also include user device 114 that may be in communication with bank server 110 or payment gateway system 104 over network 106. User device 114 may be associated with card 102 and may be used with bank server 110 or payment gateway system 104 to authenticate a user as one or more authentication factor. User device 114 may include an iPhone, iPod, iPad from Apple® or any other mobile device running Apple's iOS® operating system, any device running Microsoft's Windows® mobile operating system, any device running Google's Android® operating system, and/or any other smartphone, tablet, or like wearable mobile device. User device 114 may include processing circuitry and may contain additional components, including processors, memories, error and parity/CRC checkers, data encoders, anticollision algorithms, controllers, command decoders, security primitives and tamper-proofing hardware, as necessary to perform the functions described herein. User device 114 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into user device 114 that is available and supported by user device 114, such as a touch-screen, keyboard, mouse, cursor-control device, touch-screen, microphone, digital camera, video recorder or camcorder. These devices may be used to enter information and interact with the software and other devices described herein.

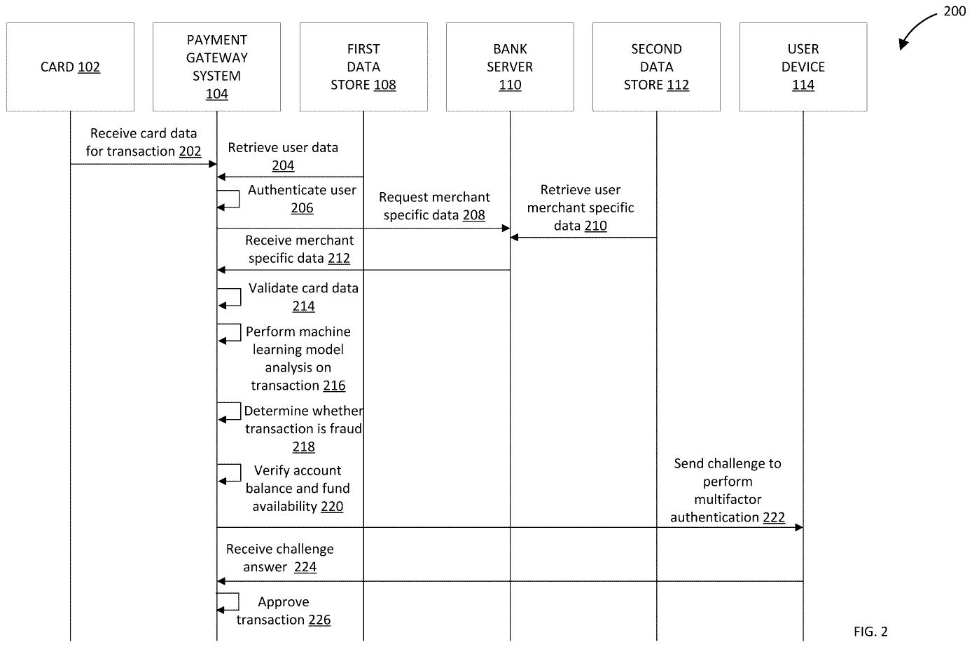

FIG. 2 is a sequence flow 200 diagram illustrating a possible sequence of events for performing decentralized payment processing according to some embodiments. This sequence flow 200 provides one example of how the decentralized payment processing is performed at an edge device (e.g., payment gateway system 104) of the payment processing network.

As shown at 202, a user may make a purchase at a merchant and then uses his card (e.g., credit card 102) to pay for the purchase (i.e., a current transaction). The purchase can be an online purchase or in-store purchase. For example, the user may make the purchase online and pick it up at one of the locations associated with the merchant, and then pay for the purchase at the one location. The user can make the purchase at a store associated with the merchant and then pay for the in-store purchase at a merchant device, such as a point of sale terminal or an in-store kiosk. For example, the user may insert, swipe, scan or tap the card to the merchant device. The merchant device can be a payment gateway device of payment gateway system 104 or the merchant device can be payment gateway system 104. At 202, payment gateway system 104 receives the card data of card 102 for the current transaction.

At 204, payment gateway system 104 may retrieve user data associated with the user from first data store 108, at least, based on the received card data of card 102. The user data can include user name, phone number, shipping address, home address, billing address, email address, date and time of an merchant account created with the merchant, login credentials of the user for the merchant account, and/or card number of card 102, and so forth.

At 206, payment gateway system 104 may authenticate the user based on the retrieved user data and/or received card data. For example, the user can be authenticated based on the login credentials of the user for the merchant account. The user can also be authenticated based on the card number, billing address and/or phone number of the user.

At 208, payment gateway system 104 may transmit to bank server 110 a request for requesting merchant specific data. Payment gateway system 104 is associated with the merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At 210, upon receiving the request for requesting merchant specific data, bank server 110 may access second data store 112 and retrieve the merchant specific data from second data store 112.

At 212, after obtaining the merchant specific data from second data store 112, bank server 110 may transmit the merchant specific data to payment gateway system 104. payment gateway system 104 receives the merchant specific data and may store the merchant specific data in its memory and/or first data store 108.

In some embodiments, payment gateway system 104 may request the merchant specific data from bank server 110 before the current transaction conducted by the user. In some other embodiments, bank server 110 may automatically transmit the merchant specific data to payment gateway system 104 without requesting the merchant specific data from payment gateway system 104, either after the current transaction or prior to the current transaction.

At 214, payment gateway system 104 may validate the card data received from card 102 based on the received merchant specific data. For example, the user may be a recurring customer of the merchant. That is, the user had at least one past transaction with the merchant prior to the current transaction using card 102. The merchant specific data can include card data of card 102 such as card number, expiration date, card holder name, bank account number associated with card 102, and card verification value. By comparing the card data received from card 102 with the card data contained in the merchant specific data, the card data received from card 102 can be verified/validated.

At 216, payment gateway system 104 may perform, using a machine learning model, an analysis on the current transaction being conducted using card 102 by the user with the merchant. The machine learning model can receive as inputs a transaction size of the current transaction (how much the purchase costs), a frequency of the current transaction (how often the current transaction is conducted comparing with past transactions), a location of the current transaction (where the current transaction is conducted), a date and time of the current transaction (when and what time the current transaction is conducted), and a merchant type of the merchant (a service provider, a department store, a restaurant, an electronics store, and so on), and/or a known behavior pattern of the user. The known behavior pattern of the user may be stored by payment gateway system 104 in first data store 108. The known behavior pattern of the user may include the transaction size of past transactions with the merchant, locations of the past transactions with the merchant, dates and times of the past transactions with the merchant, a frequency of the past transactions with the merchant, transaction types of the past transactions with the merchant (what type of services, goods, products, food are associated with the past transactions with the merchant), shipping addresses of the past transactions with the merchant, billing addresses of the past transactions with the merchant, email addresses of the past transactions with the merchant, phone numbers of the past transactions with the merchant, and/or fraud history associated with the user or the past transactions with the merchant.

At 218, payment gateway system 104 can determine whether the current transaction is a fraud transaction based on the machine learning model analysis. For example, the machine learning model may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

At 220, payment gateway system 104 can verify account balance and fund availability of the bank account associated with card 102. If the current transaction is determined as a fraud transaction, the current transaction would be cancelled by payment gateway system 104. Payment gateway system 104 may further report the current transaction as a fraud transaction to bank server 110. Payment gateway system 104 may also report the current transaction as a fraud transaction to the user through user device 114. If the current transaction is determined as a legitimate transaction, payment gateway system 104 can verify account balance and fund availability of the bank account associated with card 102 to ensure card 102 can be used to pay for the current transaction.

In some embodiments, prior to approving the current transaction, the user may be prompted to perform multifactor authentication. For example, at 222, payment gateway system 104 may send a challenge to perform multifactor authentication to user device 114. This may include the user receiving a one-time passcode (OTP) from payment gateway system 104 via user device 114. This may also include tapping their contactless card to user device 114 to send encrypted data to payment gateway system 104 or bank server 110 as described herein. The contactless card may be card 102 or another card. Multi-factor authentication may also include biometric validation. The challenge may also include a security question for the user to answer. Based on the multi-factor authentication method, the user may enter the one-time passcode into a mobile bank application installed on user device 114, tap their contactless card, provide their biometric data, or answer the security question in the mobile bank application.

At 224, this data may be sent back to payment gateway system 104 and then forwarded to first data store 108 for validation. That is, payment gateway system 104 receives the challenge answer. First data store 108 and/or payment gateway system 104 performs the validation of the challenge answer. For example, first data store 108 and/or payment gateway system 104 may compare received OTP with the stored OTP, the received security question answer to the stored security question answer, or the received biometric data to the stored biometric data to determine if they match each other. If a match is determined, the user is authenticated. If not, the current transaction may be denied and determined as a fraud transaction. In the case where the challenge answer includes encrypted data of the contactless card, first data store 108 and/or payment gateway system 104 may decrypt the encrypted data of the contactless card.

After the user is authenticated again using the multifactor authentication method, at 226, the current transaction can be approved. The user can be provided with the purchase made for the current transaction.

As disclosed herein, payment gateway system 104 as an edge device/system can take a majority of workload of processing transactions, which can significantly lighten the workload of bank server 110. This can improve transaction processing time and efficiency, thereby increasing customer's shopping experience.

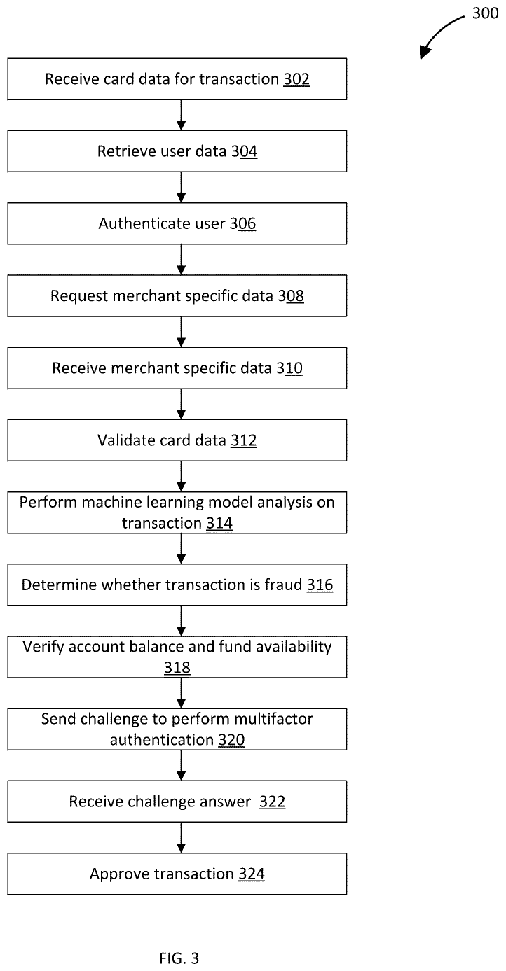

FIG. 3 is a flow chart illustrating some operations of an example method 300 for decentralized payment processing according to one embodiment. Method 300 may be performed by payment gateway system 104.

As shown at block 302, a user may make a purchase at a merchant and then uses his card (e.g., credit card 102) to pay for the purchase (i.e., a current transaction). The purchase can be an online purchase or in-store purchase. For example, the user may make the purchase online and pick it up at one of the locations associated with the merchant, and then pay for the purchase at the one location. The user can make the purchase at a store associated with the merchant and then pay for the in-store purchase at a merchant device, such as a point of sale terminal or an in-store kiosk. For example, the user may insert, swipe, scan or tap the card to the merchant device. The merchant device can be a payment gateway device of payment gateway system 104 or the merchant device can be payment gateway system 104. Method 300 includes payment gateway system 104 receiving the card data of card 102 for the current transaction.

At block 304, method 300 may include payment gateway system 104 retrieving user data associated with the user from first data store 108, at least, based on the received card data of card 102. The user data can include user name, phone number, shipping address, home address, billing address, email address, date and time of an merchant account created with the merchant, login credentials of the user for the merchant account, and/or card number of card 102, and so forth.

At block 306, payment gateway system 104 may authenticate the user based on the retrieved user data and/or received card data. For example, the user can be authenticated based on the login credentials of the user for the merchant account. The user can also be authenticated based on the card number, billing address and/or phone number of the user.

At block 308, payment gateway system 104 may transmit to bank server 110 a request for requesting merchant specific data. Payment gateway system 104 is associated with the merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

Upon receiving the request for requesting merchant specific data, bank server 110 may access second data store 112 and retrieve the merchant specific data from second data store 112. After obtaining the merchant specific data from second data store 112, bank server 110 may transmit the merchant specific data to payment gateway system 104. At block 310, method 300 may include payment gateway system 104 receiving the merchant specific data. Payment gateway system 104 may store the merchant specific data in its memory and/or first data store 108.

In some embodiments, payment gateway system 104 may request the merchant specific data from bank server 110 before the current transaction conducted by the user. In some other embodiments, bank server 110 may automatically transmit the merchant specific data to payment gateway system 104 without requesting the merchant specific data from payment gateway system 104, cither after the current transaction or prior to the current transaction.

At block 312, payment gateway system 104 may validate the card data received from card 102 based on the received merchant specific data. For example, the user may be a recurring customer of the merchant. That is, the user had at least one past transaction with the merchant prior to the current transaction using card 102. The merchant specific data can include card data of card 102 such as card number, expiration date, card holder name, bank account number associated with card 102, and card verification value. By comparing the card data received from card 102 with the card data contained in the merchant specific data, the card data received from card 102 can be verified/validated.

At block 314, payment gateway system 104 may perform, using a machine learning model, an analysis on the current transaction being conducted using card 102 by the user with the merchant. The machine learning model can receive as inputs a transaction size of the current transaction (how much the purchase costs), a frequency of the current transaction (how often the current transaction is conducted comparing with past transactions), a location of the current transaction (where the current transaction is conducted), a date and time of the current transaction (when and what time the current transaction is conducted), and a merchant type of the merchant (a service provider, a department store, a restaurant, an electronics store, and so on), and/or a known behavior pattern of the user. The known behavior pattern of the user may be stored by payment gateway system 104 in first data store 108. The known behavior pattern of the user may include the transaction size of past transactions with the merchant, locations of the past transactions with the merchant, dates and times of the past transactions with the merchant, a frequency of the past transactions with the merchant, transaction types of the past transactions with the merchant (what type of services, goods, products, food are associated with the past transactions with the merchant), shipping addresses of the past transactions with the merchant, billing addresses of the past transactions with the merchant, email addresses of the past transactions with the merchant, phone numbers of the past transactions with the merchant, and/or fraud history associated with the user or the past transactions with the merchant.

At block 316, payment gateway system 104 can determine whether the current transaction is a fraud transaction based on the machine learning model analysis. For example, the machine learning model may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

At block 318, payment gateway system 104 can verify account balance and fund availability of the bank account associated with card 102. If the current transaction is determined as a fraud transaction, the current transaction would be cancelled by payment gateway system 104. Payment gateway system 104 may further report the current transaction as a fraud transaction to bank server 110. Payment gateway system 104 may also report the current transaction as a fraud transaction to the user through user device 114. If the current transaction is determined as a legitimate transaction, payment gateway system 104 can verify account balance and fund availability of the bank account associated with card 102 to ensure card 102 can be used to pay for the current transaction.

In some embodiments, prior to approving the current transaction, the user may be prompted to perform multifactor authentication. For example, at block 320, payment gateway system 104 may send a challenge to perform multifactor authentication to user device 114. This may include the user receiving a one-time passcode (OTP) from payment gateway system 104 via user device 114. This may also include tapping their contactless card to user device 114 to send encrypted data to payment gateway system 104 or bank server 110 as described herein. The contactless card may be card 102 or another card. Multi-factor authentication may also include biometric validation. The challenge may also include a security question for the user to answer. Based on the multi-factor authentication method, the user may enter the one-time passcode into a mobile bank application installed on user device 114, tap their contactless card, provide their biometric data, or answer the security question in the mobile bank application.

At block 322, this data may be sent back to payment gateway system 104 and then forwarded to first data store 108 for validation. That is, payment gateway system 104 receives the challenge answer. First data store 108 and/or payment gateway system 104 performs the validation of the challenge answer. For example, first data store 108 and/or payment gateway system 104 may compare received OTP with the stored OTP, the received security question answer to the stored security question answer, or the received biometric data to the stored biometric data to determine if they match each other. If a match is determined, the user is authenticated. If not, the current transaction may be denied and determined as a fraud transaction. In the case where the challenge answer includes encrypted data of the contactless card, first data store 108 and/or payment gateway system 104 may decrypt the encrypted data of the contactless card.

After the user is authenticated again using the multifactor authentication method, at block 324, method 300 may include approving the current transaction. The user can be provided with the purchase made for the current transaction.

As disclosed herein, payment gateway system 104 can cache merchant specific data, and the user can be automatically approved for a transaction based on the merchant specific data without involving back end bank server 110. The user can be authorized using a contactless card (e.g., card 102) as a pre-authorization method for approving a transaction that is about to occur. In some embodiment, card 102 and payment gateway system 104 may be established a device binding relationship, so they can recognize each other, which can increase transaction security and improve transaction processing time. Bank server 110 can push decision making out to the edge (e.g., payment gateway system 104) of the payment processing network as opposed to always coming back to bank server 110 to get authorizations on transactions. As used herein, payment gateway system 104 can be a payment gateway such as PayPal, Stripe, and comprise hardware and software at the edge of the payment processing network. Payment gateway system 104 can make many decisions on transactions, and can cache information about the customers, fraud profiles (e.g., previous fraud transactions). The user can be pre-authorized the customer in the middle of the transaction process or before the transaction process.

In some embodiments, a distributed ledger can used to replace first data store 108 and/or second data store 112. Portion of card data, merchant specific data, transaction data, past transactions, fraud history and profiles, user behavior pattern data and other data can be stored in the distributed ledger. Payment gateway system 104 and bank server 110 can be authorized to access the distributed ledger to retrieve desired data. Payment gateway system 104 and bank server 110 can also be authorized to access the distributed ledger to store data in the distributed ledger. The distributed ledger can be a public the distributed ledger. The distributed ledger can be a blockchain. Using distributed ledger can reduce the number of integrations between bank server 110 and merchants, because bank server 110 just needs to push data only onto the publicly available distributed ledger and the merchants can obtain the data from the publicly available distributed ledger.

In some embodiments, a distributed artificial intelligence (AI) model and/or a machine learning model can be used on payment gateway system 104. The AI model can be configured to learn about the transactions occurring at the edge (payment gateway system 104) and then decide which of those transaction could be fraudulent. The AI model can perform all those tasks in real time, based on historical patterns and other fraud data.

For a recurring user, a device binding relationship can be established. As such, the user can be effectively pre-authorized to complete a transaction at payment gateway system 104 without going back to bank server 110. The pre-authorization to complete a transaction can be made even before card 102 is used, which can significantly speed transactions up.

Since the user can be recurring customer with the merchant, bank server 110 do not need to push out all the information that bank server 110 has to the edge of the payment processing network. Bank server 110 just needs to push out the information about the merchant and the user that has transacted at that merchant in the past. Thus, the merchant specific data can be a subset of that data bank server 110 has. Payment gateway system 104 can also run a fraud model to determine whether a transaction is fraudulent, at least based on the merchant specific data.

In some embodiments, the AI model can predict the user may go shopping at a second merchant because the user was shopping at a first merchant in the past. The second merchant is a similar type of merchant as the first merchant, for example, both the first merchant and the second merchant can be drug stores.

In some embodiment, the AI and/or machine learning model can predict what is going to be the next purchase for the user. Based on this, bank sever 110 can be proactive about pushing that data to the edge. So that data can be available when the user does what they are predicted to do.

In some embodiment, the fraud model can be a merchant specific fraud model, because there has certain type of fraud that occurs more often at a first merchant than a second merchant. The merchant specific fraud model can be more accurate to detect fraud at a specific merchant.

In some embodiment, the public distributed ledger can be a blockchain. Data security can be handled by the blockchain itself, so a secure data repository for all data for payment gateway system 104 may not be needed (e.g., first data store 108) As a public distributed ledger, all data can be encrypted, which can make it easier for the integration between payment gateway system 104 and bank server 110. Payment gateway system 104 and bank server 110 can access the public distributed ledger via one or more application programming interfaces (API). Since data in the public distributed ledger is encrypted, payment gateway system 104 and bank server 110 may decrypt the data.

In some embodiment, the payment processing, if necessary, may fall back, the centralized processing system. That is, bank server 110 may authorize transactions, check fund availability, authenticate users, perform fraud check, and so on.

In some embodiments, the merchant specific data may be stored at payment gateway system 104 and/or first data store 108 up to date for a period of time.

In some embodiments, the fraud model may take other data sets from other issuers to make the fraud modeling much stronger.

In some embodiments, the merchant specific data may be pushed by bank server 110 to at payment gateway system 104 based on a priority. For example, a user may shop at a merchant more often on a regular basis, the merchant specific data associated with this user may be pushed by bank server 110 to at payment gateway system 104. If a user just shops once a year at a merchant, the merchant specific data associated with that user may not be pushed by bank server 110 to at payment gateway system 104.

In some embodiment, the user behavior pattern data may be obtained from a website associated with the merchant, which is then shared with payment gateway system 104. For example, the user may be always shopping in the beauty section on the website. If the user strays over into a different section, that may be a flag for fraud. If transactional amounts are increasing, or the suer is shopping, for example, at 3 o'clock in the morning, when the user is usually shopping at noon. The website could determine such information as an indicator of potential fraud flags, and may pass those fraud flags over to payment gateway system 104.

In some embodiments, the merchant specific data may be pulled instead of pushed to payment gateway system 104. For example, the user may tap a contactless card to payment gateway system 104, and the merchant specific data can then be pulled from bank server 110 and/or second data store 112 to payment gateway system 104. The user can be preauthorized to the transaction that the user is about to make.

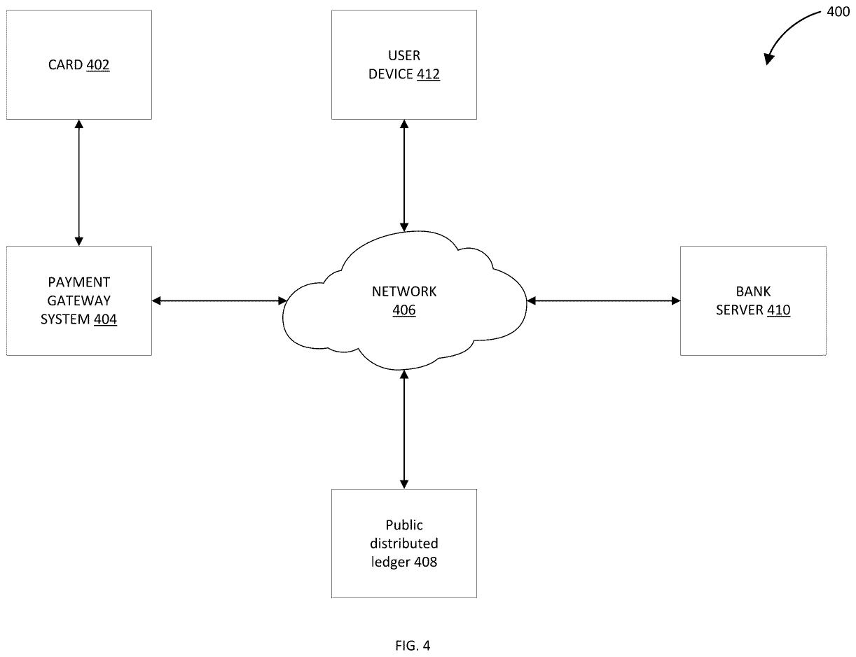

FIG. 4 illustrates system 400 for providing decentralized payment processing at the edge of the payment processing network according to an example embodiment. As further discussed below, system 400 may include card 402, payment gateway system 404, network 406, public distributed ledger 408, bank server 410, and user device 412. Although FIG. 4 illustrates single instances of the components, system 400 may include any number of components.

System 400 may include one or more cards 402. In some embodiments, card 402 may be in wireless communication, utilizing near field communication (NFC) in an example, with payment gateway system 404 and user device 412. As described below, card 402 may provide one factor of authentication to authenticate an identity of the user of the payment gateway system 404.

In some embodiment, card 402 may include a contactless card, a payment card, such as a credit card, debit card, or gift card, issued by a service provider as displayed as service provider indicia on the front or back of card 402. The service provider may be a financial institution, such as a bank that is associated with bank server 410. In some examples, card 402 is not related to a payment card, and may include, without limitation, an identification card. In some examples, card 402 may include a dual interface contactless payment card, a rewards card, and so forth. Card 402 may include a substrate, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, card 402 may have physical characteristics compliant with the ID-4 format of the ISO/IEC 7846 standard, and may otherwise be compliant with the ISO/IEC 41243 standard. However, it is understood that card 402 according to the present disclosure may have different characteristics, and the present disclosure does not require card 402 to be implemented in a payment card.

Card 402 may also include identification information displayed on the front and/or back of card 402, and a contact pad. The contact pad may include one or more pads and be configured to establish contact with another device, such as an automated teller machine (ATM), user device 412, smartphone, laptop, desktop, or tablet computer. The contact pad may be designed in accordance with one or more standards, such as ISO/IEC 7846 standard, and enable communication in accordance with the EMV protocol. Card 402 may also include processing circuitry, antenna and other components. These components may be located behind the contact pad or elsewhere on the substrate, e.g. within a different layer of the substrate, and may electrically and physically coupled with the contact pad. Card 402 may also include a magnetic strip or tape, which may be located on the back of card 402. Card 402 may also include a Near-Field Communication (NFC) device coupled with an antenna capable of communicating via the NFC protocol. Embodiments are not limited in this manner. The contact pad of card 402 may include processing circuitry for storing, processing, and communicating information, including a processor, a memory, and one or more interface(s). It is understood that the processing circuitry may contain additional components, including processors, memories, error and parity/CRC checkers, data encoders, anticollision algorithms, controllers, command decoders, security primitives and tamperproofing hardware, as necessary to perform the functions described herein.

The memory of the contact pad may be a read-only memory, write-once read-multiple memory or read/write memory, e.g., RAM, ROM, and EEPROM, and card 402 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory may be encrypted memory utilizing an encryption algorithm executed by the processor to encrypted data.

The memory of the contact pad may be configured to store one or more applet(s), one or more counter(s), a customer identifier, and an account number(s), which may be virtual account numbers. The one or more applet(s) may comprise one or more software applications configured to execute on one or more contactless cards, such as a Java® Card applet. However, it is understood that applet(s) are not limited to Java Card applets, and instead may be any software application operable on contactless cards or other devices having limited memory. The one or more counter(s) may comprise a numeric counter sufficient to store an integer. The customer identifier may comprise a unique alphanumeric identifier assigned to a user of card 402, and the identifier may distinguish the user of card 402 from other contactless card users. In some examples, the customer identifier may identify both a customer and an account assigned to that customer and may further identify card 402 associated with the customer's account. As stated, the account number(s) may include thousands of one-time use virtual account numbers associated with card 402. An applet(s) of card 402 may be configured to manage the account number(s) (e.g., to select an account number(s), mark the selected account number(s) as used, and transmit the account number(s) to user device 412 or payment gateway system 404 for autofilling by an autofilling service.

In some examples, card 402 may comprise one or more antenna(s). The one or more antenna(s) may be placed within card 402 and around the processing circuitry of the contact pad. For example, the one or more antenna(s) may be integral with the processing circuitry and the one or more antenna(s) may be used with an external booster coil. As another example, the one or more antenna(s) may be external to the contact pad and the processing circuitry.

In an embodiment, coil of card 402 may act as the secondary of an air core transformer. A terminal, such as user device 412 or payment gateway system 404 may communicate with card 402 by cutting power or amplitude modulation. Card 402 may infer the data transmitted from the terminal using the gaps in the contactless card's power connection, which may be functionally maintained through one or more capacitors. Card 402 may communicate back by switching a load on the contactless card's coil or load modulation. Load modulation may be detected in the terminal's coil through interference. More generally, using the antenna(s), processor, and/or the memory, card 402 provides a communications interface to communicate via NFC, Bluetooth, and/or Wi-Fi communications.

As explained above, card 402 may be built on a software platform operable on smart cards or other devices having limited memory, such as JavaCard, and one or more or more applications or applets may be securely executed. Applet(s) may be added to contactless cards to provide a one-time password (OTP) for multifactor authentication (MFA) in various mobile application-based use cases. Applet(s) may be configured to respond to one or more requests, such as near field data exchange requests, from a reader, such as a mobile NFC reader (e.g., of User device 412 or point-of-sale terminal such as payment gateway system 404), and produce an NFC Data Exchange Format (NDEF) message that comprises a cryptographically secure OTP encoded as an NDEF text tag.

One example of an NDEF OTP is an NDEF short-record layout (SR=4). In such an example, one or more applet(s) may be configured to encode the OTP as an NDEF type 4 well known type text tag. In some examples, NDEF messages may comprise one or more records. The applet(s) may be configured to add one or more static tag records in addition to the OTP record.

In some examples, the one or more applet(s) may be configured to emulate a radio frequency identification (RFID) tag. The RFID tag may include one or more polymorphic tags. In some examples, each time the tag is read, different cryptographic data is presented that may indicate the authenticity of the contactless card. Based on the one or more applet(s), an NFC read of the tag may be processed, the data may be transmitted to a server, such as bank server 410 of a banking system, and the data may be validated at the server.

In some examples, card 402 may include certain data such that card 402 may be properly identified. Each time a read operation takes place, the counter(s) may be configured to increment. In some examples, each time data from card 402 is read (e.g., by user device 412), the counter(s) is transmitted to bank server 410 for validation and determines whether the counter(s) are equal (as part of the validation) to a counter of bank server 410.

The one or more counter(s) may be configured to prevent a replay attack. For example, if a cryptogram has been obtained and replayed, that cryptogram is immediately rejected if the counter(s) has been read or used or otherwise passed over. If the counter(s) has not been used, it may be replayed.

In some examples, the counter(s) may get out of sync. In some examples, to account for accidental reads that initiate transactions, such as reading at an angle, the counter(s) may increment but the application on user device 412 or payment gateway system 404 does not process the counter(s). In some examples, when payment gateway system 404 is woken up, NFC may be enabled and payment gateway system 404 may be configured to read available tags, but no action is taken responsive to the reads.

To keep the counter(s) in sync, an application, such as a background application, may be executed that would be configured to detect when payment gateway system 404 wakes up and synchronize with bank server 410 of a banking system indicating that a read that occurred due to detection to then move the counter(s) forward. In other examples, Hashed One Time Password may be utilized such that a window of mis-synchronization may be accepted. For example, if within a threshold of 40, the counter(s) may be configured to move forward. But if within a different threshold number, for example within 40 or 4000, a request for performing re-synchronization may be processed which requests via one or more applications that the user tap, gesture, or otherwise indicate one or more times via user device 412. If the counter(s) increases in the appropriate sequence, then it possible to know that the user has done so.

The key diversification technique described herein with reference to the counter(s), master key, and diversified key, is one example of encryption and/or decryption. This example key diversification technique should not be considered limiting of the disclosure, as the disclosure is equally applicable to other types of key diversification techniques.

During the creation process of card 402, two cryptographic keys may be assigned uniquely per card. The cryptographic keys may comprise symmetric keys which may be used in both encryption and decryption of data. Triple DES (3DES) algorithm may be used by EMV and it is implemented by hardware in card 402. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time card 402 is used in operation, a different key may be used for creating a message authentication code (MAC) and for performing the encryption. This results in a triple layer of cryptography. The session keys may be generated by the one or more applets and derived by using the application transaction counter with one or more algorithms (as defined in EMV 4.3 Book 2 A4.3.4 Common Session Key Derivation).

Further, the counter increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 4, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

System 400 may include payment gateway system 404, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. payment gateway system 404 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Payment gateway system 404 can include a processor and a memory, and it is understood that the processor may contain additional components, including processors, memories, error and parity/CRC checkers, data encoders, anticollision algorithms, controllers, command decoders, security primitives and tamperproofing hardware, as necessary to perform the functions described herein. Payment gateway system 404 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, payment gateway system 404 may execute one or more applications, such as software applications, that enable, for example, network communications with one or more components of system 400 and transmit and/or receive data.

Payment gateway system 404 may be in communication with one or more servers/devices such as public distributed ledger 408, bank server 410, and/or user device 412 via one or more network(s) 406, and may operate as a respective front-end to back-end pair with any of those servers/devices. Payment gateway system 404 may transmit, for example from a software application (e.g., a browser) executing on payment gateway system 404, one or more requests to public distributed ledger 408. The one or more requests may be associated with retrieving data from public distributed ledger 408. Public distributed ledger 408 may receive the one or more requests from payment gateway system 404. Based on the one or more requests from payment gateway system 404, public distributed ledger 408 may be configured to retrieve the requested data. Public distributed ledger 408 may be configured to transmit the retrieved data to payment gateway system 404, the retrieved data being responsive to the one or more requests. This may include loading transaction history, user behavior pattern data, and fraud-related data from public distributed ledger 408.radio frequency identification.

In some embodiments, payment gateway system 404 can include a service that allows businesses to accept, process, and manage payments from customers. It acts as an intermediary between a merchant and their bank or processor to securely transfer funds from the customer's payment method to the merchant. Payment gateway system 440 can be used for in-person, online, or in-app payments, and can accept various payment methods, including credit cards, debit cards, and digital wallets. Payment gateway system 404 can also use encryption tools and safety protocols to ensure secure transactions, such as Transport Layer Security (TLS) or Secure Sockets Layer (SSL) certificates, Payment Card Industry Data Security Standard (PCI DSS) compliance, and fraud prevention tools like Address Verification Service (AVS) and/or Card Verification Value (CVV).

System 400 may include one or more networks 406. In some examples, network 406 may be one or more of a wireless network, a wired network or any combination of wireless network and wired network, and may be configured to connect payment gateway system 404 to bank server 410, and user device 412. For example, network 406 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.44 family of networking, Bluetooth, NFC, Radio Frequency Identification (RFID), Wi-Fi, and/or the like.

In addition, network 406 may include, without limitation, telephone lines, fiber optics, IEEE Ethernet 802.3, a wide area network, a wireless personal area network, a LAN, or a global network such as the Internet. In addition, network 406 may support an Internet network, a wireless communication network, a cellular network, or the like, or any combination thereof. network 406 may further include one network, or any number of the exemplary types of networks mentioned above, operating as a stand-alone network or in cooperation with each other. network 406 may utilize one or more protocols of one or more network elements to which they are communicatively coupled. Network 406 may translate to or from other protocols to one or more protocols of network devices. Although network 406 is depicted as a single network, it should be appreciated that according to one or more examples, network 406 may comprise a plurality of interconnected networks, such as, for example, the Internet, a service provider's network, a cable television network, corporate networks, such as credit card association networks, and home networks.

System 400 may include one or more public distributed ledger 408. A distributed ledger can be a transaction database that is stored and synchronized across multiple sites, institutions, or geographies. Network nodes store copies of the ledger and communicate any changes made by users to other nodes, which append their ledgers to match. Distributed ledger 408 can be blockchains.

Public distributed ledger 408 can store user's transaction history, personal identifying information of users, user's purchase behavior patterns, fraud data, and so on. Public distributed ledger 408 can be a database. The database may comprise a relational database, a non-relational database, or other database implementations, and any combination thereof, including a plurality of relational databases and non-relational databases. In some examples, public distributed ledger 408 may comprise a desktop database, a mobile database, or an in-memory database. Further, public distributed ledger 408 may be hosted internally by payment gateway system 404 or bank server 410, or public distributed ledger 408 may be hosted externally to any component of system 400, such as by a cloud-based platform, or in any storage device that is in data communication with payment gateway system 404. In some examples, public distributed ledger 408 may be in data communication with any number of components of system 400.

Public distributed ledger 408 may operate to provide authentication services for the user. For example, in some embodiments, Public distributed ledger 408 can receive and decrypt encrypted data from card 402 to act as a validation system of the identity of the user of payment gateway system 404 and user device 412. Public distributed ledger 408 can therefore provide a factor of authentication for the system described herein. Public distributed ledger 408 can store user's bank account information, information of card 402 such as real card number, virtual card number, expiration date, card verification value (CVV), mailing and billing addresses of the user, transaction data history, account balance, available fund, and so forth. Bank server 410 can communicate such information to public distributed ledger 408 to be stored on public distributed ledger 408.

Public distributed ledger 408 can reduce the risk of fraud because the nodes can be programmed to compare their states and reject unverified changes. Data on public distributed ledger 408 can be collected and entered into digital files and then stored on computers. These files make up ledgers. Software is used to access and use this data, and access is granted to users who require it. Public distributed ledger 408 can be stored in central locations and controlled by specific users. These locations could be a closed network on a storage system stored in a room and maintained by system technicians. Data on public distributed ledger 408 can be audited and verified.

On public distributed ledger 408, identical copies of data are allowed to be stored on multiple machines in different geographies. The computers, called nodes, automatically update their ledger copies and broadcast their states to other nodes. All nodes are programmed to verify other nodes' ledgers, and the network maintains its database. Distributed ledgers are inherently harder to attack because a majority of the distributed copies need to be altered simultaneously for them to be successful. Because of their distributed nature, these records are resistant to malicious changes by a single party. Distributed ledgers can also allow for much more transparency than is available in centralized ledgers. This transparency makes an audit trail much easier when conducting data audits and financial reviews. This helps remove the possibility of fraud occurring on the financial books of a company. Distributed ledgers also reduce operational inefficiencies and speed up the amount of time a transaction takes to complete. They are automated and, therefore, can function 24/7. All of these factors reduce overall costs for the entities. Most of this work on public distributed ledger 408 is done using encryption techniques such as hashing data and then comparing it, which is done very quickly on modern computers and networks.

System 400 may include bank server 410. Bank server 410 may include a memory and one or more processors, which are coupled to the memory. Bank server 410 may be configured to transmit user card data to payment gateway system 404 via public distributed ledger 408 to allow payment gateway system 404 for authorizing transactions. Bank server 410 may be a server controlled by a financial institution. Bank server 410 may host a banking application which payment gateway system 404 and user device 412 can download, and payment gateway system 404 and bank server 410 can operates as a frontend to backend pair for the banking application.

Bank server 410 can host a bank application backend. When the user uses a mobile bank application on payment gateway system 404 or user device 412, the data populated on the mobile bank application can be pulled from bank server 440 for display. In some embodiments, bank server 410 can include a browser cookie generator. In some embodiments, the browser cookie generator can generate the temporary browser data file (e.g., the HTTP cookie). This unique HTTP cookie generated on enrolled devices creates device binding/trust for the user. Users who enroll after logging in with their bank credentials in the browser can create a device HTTP cookie.

System 400 may also include user device 412 that may be in communication with bank server 410 or payment gateway system 404 over network 406. User device 412 may be associated with card 402 and may be used with bank server 410 or payment gateway system 404 to authenticate a user as one or more authentication factor. User device 412 may include an iPhone, iPod, iPad from Apple® or any other mobile device running Apple's iOS® operating system, any device running Microsoft's Windows® mobile operating system, any device running Google's Android® operating system, and/or any other smartphone, tablet, or like wearable mobile device. User device 412 may include processing circuitry and may contain additional components, including processors, memories, error and parity/CRC checkers, data encoders, anticollision algorithms, controllers, command decoders, security primitives and tamper-proofing hardware, as necessary to perform the functions described herein. User device 412 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into user device 412 that is available and supported by user device 412, such as a touch-screen, keyboard, mouse, cursor-control device, touch-screen, microphone, digital camera, video recorder or camcorder. These devices may be used to enter information and interact with the software and other devices described herein.

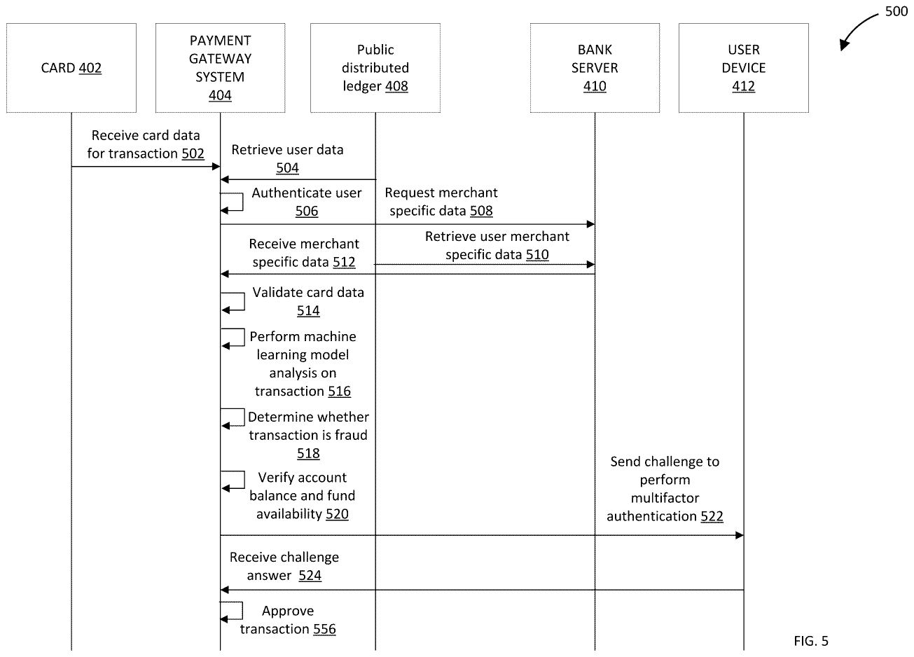

FIG. 5 is a sequence flow 500 diagram illustrating a possible sequence of events for performing decentralized payment processing according to some embodiments. This sequence flow 500 provides one example of how the decentralized payment processing is performed at an edge device (e.g., payment gateway system 404) of the payment processing network.

As shown at 502, a user may make a purchase at a merchant and then uses his card (e.g., credit card 402) to pay for the purchase (i.e., a current transaction). The purchase can be an online purchase or in-store purchase. For example, the user may make the purchase online and pick it up at one of the locations associated with the merchant, and then pay for the purchase at the one location. The user can make the purchase at a store associated with the merchant and then pay for the in-store purchase at a merchant device, such as a point of sale terminal or an in-store kiosk. For example, the user may insert, swipe, scan or tap the card to the merchant device. The merchant device can be a payment gateway device of payment gateway system 404 or the merchant device can be payment gateway system 404. At 502, payment gateway system 404 receives the card data of card 402 for the current transaction.

At 504, payment gateway system 404 may retrieve user data associated with the user from public distributed ledger 408, at least, based on the received card data of card 402. The user data can include user name, phone number, shipping address, home address, billing address, email address, date and time of an merchant account created with the merchant, login credentials of the user for the merchant account, and/or card number of card 402, and so forth. Payment gateway system 404 may access public distributed ledger 408 via one or more APIs.

At 506, payment gateway system 404 may authenticate the user based on the retrieved user data and/or received card data. For example, the user can be authenticated based on the login credentials of the user for the merchant account. The user can also be authenticated based on the card number, billing address and/or phone number of the user. The user data retrieved from public distributed ledger 408 may be encrypted. Payment gateway system 404 may decrypt the encrypted data.

At 508, payment gateway system 404 may transmit to bank server 410 a request for requesting merchant specific data. Payment gateway system 404 is associated with the merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At 510, upon receiving the request for requesting merchant specific data, bank server 410 may access public distributed ledger 408 and retrieve the merchant specific data from public distributed ledger 408. Bank server 410 may access public distributed ledger 408 via one or more APIs. The merchant specific data retrieved from public distributed ledger 408 may be encrypted. Bank server 410 may decrypt the encrypted data. In some embodiments, Bank server 410 may not decrypt the encrypted data.

At 512, after obtaining the merchant specific data from public distributed ledger 408, bank server 410 may transmit the merchant specific data to payment gateway system 404. payment gateway system 404 receives the merchant specific data and may store the merchant specific data in its memory and/or public distributed ledger 408. Payment gateway system 404 may decrypt the encrypted merchant specific data, if not decrypted by bank server 410.

In some embodiments, payment gateway system 404 may request the merchant specific data from bank server 410 before the current transaction conducted by the user. In some other embodiments, bank server 410 may automatically transmit the merchant specific data to payment gateway system 404 without requesting the merchant specific data from payment gateway system 404, cither after the current transaction or prior to the current transaction.

At 514, payment gateway system 404 may validate the card data received from card 402 based on the received merchant specific data. For example, the user may be a recurring customer of the merchant. That is, the user had at least one past transaction with the merchant prior to the current transaction using card 402. The merchant specific data can include card data of card 402 such as card number, expiration date, card holder name, bank account number associated with card 402, and card verification value. By comparing the card data received from card 402 with the card data contained in the merchant specific data, the card data received from card 402 can be verified/validated.

At 516, payment gateway system 404 may perform, using a machine learning model, an analysis on the current transaction being conducted using card 402 by the user with the merchant. The machine learning model can receive as inputs a transaction size of the current transaction (how much the purchase costs), a frequency of the current transaction (how often the current transaction is conducted comparing with past transactions), a location of the current transaction (where the current transaction is conducted), a date and time of the current transaction (when and what time the current transaction is conducted), and a merchant type of the merchant (a service provider, a department store, a restaurant, an electronics store, and so on), and/or a known behavior pattern of the user. The known behavior pattern of the user may be stored by payment gateway system 404 in public distributed ledger 408. The known behavior pattern of the user may include the transaction size of past transactions with the merchant, locations of the past transactions with the merchant, dates and times of the past transactions with the merchant, a frequency of the past transactions with the merchant, transaction types of the past transactions with the merchant (what type of services, goods, products, food are associated with the past transactions with the merchant), shipping addresses of the past transactions with the merchant, billing addresses of the past transactions with the merchant, email addresses of the past transactions with the merchant, phone numbers of the past transactions with the merchant, and/or fraud history associated with the user or the past transactions with the merchant.

At 518, payment gateway system 404 can determine whether the current transaction is a fraud transaction based on the machine learning model analysis. For example, the machine learning model may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

At 520, payment gateway system 404 can verify account balance and fund availability of the bank account associated with card 402. If the current transaction is determined as a fraud transaction, the current transaction would be cancelled by payment gateway system 404. Payment gateway system 404 may further report the current transaction as a fraud transaction to bank server 410. Payment gateway system 404 may also report the current transaction as a fraud transaction to the user through user device 412. If the current transaction is determined as a legitimate transaction, payment gateway system 404 can verify account balance and fund availability of the bank account associated with card 402 to ensure card 402 can be used to pay for the current transaction.

In some embodiments, prior to approving the current transaction, the user may be prompted to perform multifactor authentication. For example, at 522, payment gateway system 404 may send a challenge to perform multifactor authentication to user device 412. This may include the user receiving a one-time passcode (OTP) from payment gateway system 404 via user device 412. This may also include tapping their contactless card to user device 412 to send encrypted data to payment gateway system 404 or bank server 410 as described herein. The contactless card may be card 402 or another card. Multi-factor authentication may also include biometric validation. The challenge may also include a security question for the user to answer. Based on the multi-factor authentication method, the user may enter the one-time passcode into a mobile bank application installed on user device 412, tap their contactless card, provide their biometric data, or answer the security question in the mobile bank application.

At 524, this data may be sent back to payment gateway system 404 and then forwarded to public distributed ledger 408 for validation. That is, payment gateway system 404 receives the challenge answer. Public distributed ledger 408 and/or payment gateway system 404 performs the validation of the challenge answer. For example, public distributed ledger 408 and/or payment gateway system 404 may compare received OTP with the stored OTP, the received security question answer to the stored security question answer, or the received biometric data to the stored biometric data to determine if they match each other. If a match is determined, the user is authenticated. If not, the current transaction may be denied and determined as a fraud transaction. In the case where the challenge answer includes encrypted data of the contactless card, public distributed ledger 408 and/or payment gateway system 404 may decrypt the encrypted data of the contactless card.

After the user is authenticated again using the multifactor authentication method, at 526, the current transaction can be approved. The user can be provided with the purchase made for the current transaction.

As disclosed herein, payment gateway system 404 as an edge device/system can take a majority of workload of processing transactions, which can significantly lighten the workload of bank server 410. This can improve transaction processing time and efficiency, thereby increasing customer's shopping experience.

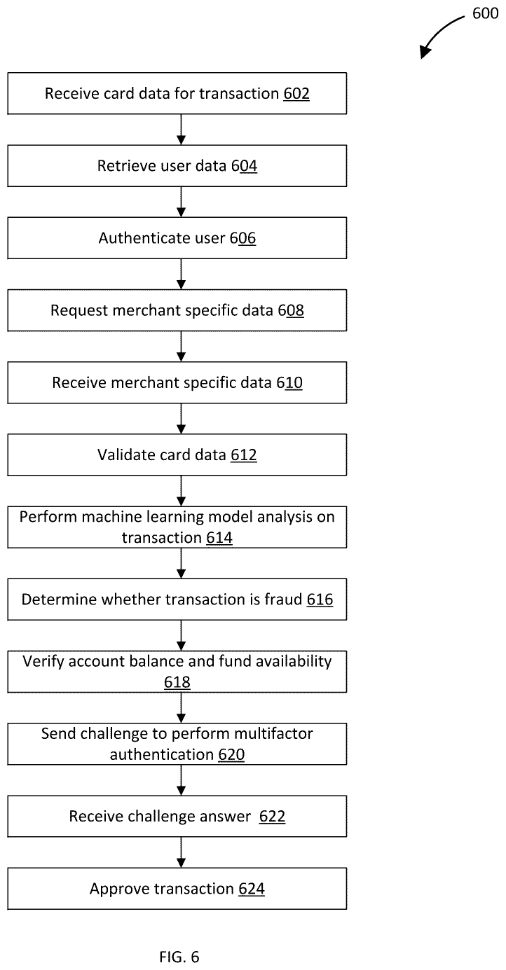

FIG. 6 is a flow chart illustrating some operations of an example method 600 for decentralized payment processing according to one embodiment. Method 600 may be performed by payment gateway system 404.

As shown at block 602, a user may make a purchase at a merchant and then uses his card (e.g., credit card 402) to pay for the purchase (i.e., a current transaction). The purchase can be an online purchase or in-store purchase. For example, the user may make the purchase online and pick it up at one of the locations associated with the merchant, and then pay for the purchase at the one location. The user can make the purchase at a store associated with the merchant and then pay for the in-store purchase at a merchant device, such as a point of sale terminal or an in-store kiosk. For example, the user may insert, swipe, scan or tap the card to the merchant device. The merchant device can be a payment gateway device of payment gateway system 404 or the merchant device can be payment gateway system 404. At block 602, payment gateway system 404 receives the card data of card 402 for the current transaction.

At block 604, payment gateway system 404 may retrieve user data associated with the user from public distributed ledger 408, at least, based on the received card data of card 402. The user data can include user name, phone number, shipping address, home address, billing address, email address, date and time of an merchant account created with the merchant, login credentials of the user for the merchant account, and/or card number of card 402, and so forth. Payment gateway system 404 may access public distributed ledger 408 via one or more APIs.

At block 606, payment gateway system 404 may authenticate the user based on the retrieved user data and/or received card data. For example, the user can be authenticated based on the login credentials of the user for the merchant account. The user can also be authenticated based on the card number, billing address and/or phone number of the user. The user data retrieved from public distributed ledger 408 may be encrypted. Payment gateway system 404 may decrypt the encrypted data.

At block 608, payment gateway system 404 may transmit to bank server 410 a request for requesting merchant specific data. Payment gateway system 404 is associated with the merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At block 610, upon receiving the request for requesting merchant specific data, bank server 410 may access public distributed ledger 408 and retrieve the merchant specific data from public distributed ledger 408. Bank server 410 may access public distributed ledger 408 via one or more APIs. The merchant specific data retrieved from public distributed ledger 408 may be encrypted. Bank server 410 may decrypt the encrypted data. In some embodiments, Bank server 410 may not decrypt the encrypted data.

At block 612, after obtaining the merchant specific data from public distributed ledger 408, bank server 410 may transmit the merchant specific data to payment gateway system 404. payment gateway system 404 receives the merchant specific data and may store the merchant specific data in its memory and/or public distributed ledger 408. Payment gateway system 404 may decrypt the encrypted merchant specific data, if not decrypted by bank server 410.

In some embodiments, payment gateway system 404 may request the merchant specific data from bank server 410 before the current transaction conducted by the user. In some other embodiments, bank server 410 may automatically transmit the merchant specific data to payment gateway system 404 without requesting the merchant specific data from payment gateway system 404, either after the current transaction or prior to the current transaction.

At block 614, payment gateway system 404 may validate the card data received from card 402 based on the received merchant specific data. For example, the user may be a recurring customer of the merchant. That is, the user had at least one past transaction with the merchant prior to the current transaction using card 402. The merchant specific data can include card data of card 402 such as card number, expiration date, card holder name, bank account number associated with card 402, and card verification value. By comparing the card data received from card 402 with the card data contained in the merchant specific data, the card data received from card 402 can be verified/validated.

At block 616, payment gateway system 404 may perform, using a machine learning model, an analysis on the current transaction being conducted using card 402 by the user with the merchant. The machine learning model can receive as inputs a transaction size of the current transaction (how much the purchase costs), a frequency of the current transaction (how often the current transaction is conducted comparing with past transactions), a location of the current transaction (where the current transaction is conducted), a date and time of the current transaction (when and what time the current transaction is conducted), and a merchant type of the merchant (a service provider, a department store, a restaurant, an electronics store, and so on), and/or a known behavior pattern of the user. The known behavior pattern of the user may be stored by payment gateway system 404 in public distributed ledger 408. The known behavior pattern of the user may include the transaction size of past transactions with the merchant, locations of the past transactions with the merchant, dates and times of the past transactions with the merchant, a frequency of the past transactions with the merchant, transaction types of the past transactions with the merchant (what type of services, goods, products, food are associated with the past transactions with the merchant), shipping addresses of the past transactions with the merchant, billing addresses of the past transactions with the merchant, email addresses of the past transactions with the merchant, phone numbers of the past transactions with the merchant, and/or fraud history associated with the user or the past transactions with the merchant.

At block 618, payment gateway system 404 can determine whether the current transaction is a fraud transaction based on the machine learning model analysis. For example, the machine learning model may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

At block 620, payment gateway system 404 can verify account balance and fund availability of the bank account associated with card 402. If the current transaction is determined as a fraud transaction, the current transaction would be cancelled by payment gateway system 404. Payment gateway system 404 may further report the current transaction as a fraud transaction to bank server 410. Payment gateway system 404 may also report the current transaction as a fraud transaction to the user through user device 412. If the current transaction is determined as a legitimate transaction, payment gateway system 404 can verify account balance and fund availability of the bank account associated with card 402 to ensure card 402 can be used to pay for the current transaction.

In some embodiments, prior to approving the current transaction, the user may be prompted to perform multifactor authentication. For example, at block 622, payment gateway system 404 may send a challenge to perform multifactor authentication to user device 412. This may include the user receiving a one-time passcode (OTP) from payment gateway system 404 via user device 412. This may also include tapping their contactless card to user device 412 to send encrypted data to payment gateway system 404 or bank server 410 as described herein. The contactless card may be card 402 or another card. Multi-factor authentication may also include biometric validation. The challenge may also include a security question for the user to answer. Based on the multi-factor authentication method, the user may enter the one-time passcode into a mobile bank application installed on user device 412, tap their contactless card, provide their biometric data, or answer the security question in the mobile bank application.

At block 624, this data may be sent back to payment gateway system 404 and then forwarded to public distributed ledger 408 for validation. That is, payment gateway system 404 receives the challenge answer. Public distributed ledger 408 and/or payment gateway system 404 performs the validation of the challenge answer. For example, public distributed ledger 408 and/or payment gateway system 404 may compare received OTP with the stored OTP, the received security question answer to the stored security question answer, or the received biometric data to the stored biometric data to determine if they match each other. If a match is determined, the user is authenticated. If not, the current transaction may be denied and determined as a fraud transaction. In the case where the challenge answer includes encrypted data of the contactless card, public distributed ledger 408 and/or payment gateway system 404 may decrypt the encrypted data of the contactless card.

After the user is authenticated again using the multifactor authentication method, at block 626, the current transaction can be approved. The user can be provided with the purchase made for the current transaction.

As disclosed herein, payment gateway system 404 as an edge device/system can take a majority of workload of processing transactions, which can significantly lighten the workload of bank server 410. This can improve transaction processing time and efficiency, thereby increasing customer's shopping experience.

In some embodiments, a contactless card (e.g., card 102 and 404) can be used for authentication of the user by payment gateway system 104/404 and/or for performing multi-factor authentication. For example, payment gateway system 104/404 communicates with card 102 (e.g., after being brought near card 102). Communication between payment gateway system 104/404 and card 102 may involve card 102 being sufficiently close to a card reader (not shown) of payment gateway system 104/404 to enable NFC data transfer between payment gateway system 104/404 and card 102.

After communication has been established between payment gateway system 104/404 and card 102, card 102 generates a message authentication code (MAC) cryptogram. In some examples, this may occur when card 102 is read by payment gateway system 104/404. In particular, this may occur upon a read, such as an NFC read, of a near field data exchange (NDEF) tag, which may be created in accordance with the NFC Data Exchange Format. For example, payment gateway system 104/404, may transmit a message, such as an applet select message, with the applet ID of an NDEF producing applet. Upon confirmation of the selection, a sequence of select file messages followed by read file messages may be transmitted. The sequence may include “Select Capabilities file”, “Read Capabilities file”, and “Select NDEF file”. At this point, a counter value maintained by card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, payment gateway system 104/404 may be configured to transmit a request to card 102, the request comprising an instruction to generate a MAC cryptogram.

Card 102 sends the MAC cryptogram to payment gateway system 104/404. In some examples, the transmission of the MAC cryptogram occurs via NFC, however, the present disclosure is not limited thereto. In other examples, this communication may occur via Bluetooth, Wi-Fi, or other means of wireless data communication.

Payment gateway system 104/404 may verify the MAC cryptogram. For example, the MAC cryptogram may be verified, as explained below. In some examples, verifying the MAC cryptogram may be performed by a device other than payment gateway system 104/404, such as a server (e.g., bank server 110/410) of a banking system in data communication with payment gateway system 104/404. For example, payment gateway system 104/404 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

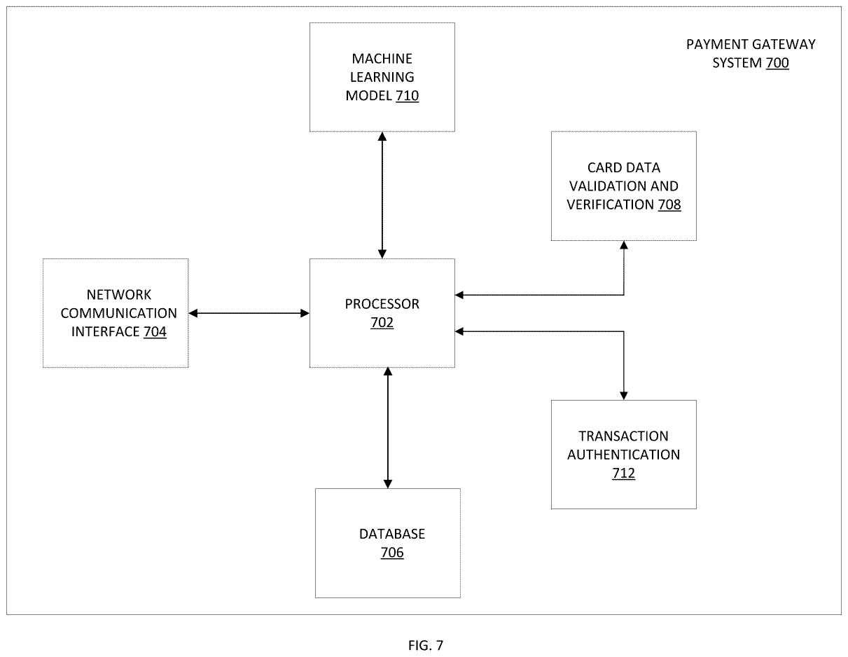

FIG. 7 illustrates an embodiment of an exemplary payment gateway system 700 suitable for implementing various embodiments as previously described. Payment gateway system 700 can be payment gateway system 104 and 404. In one embodiment, payment gateway system 700 may include or be implemented as part or component of one or more systems or devices discussed herein. In another embodiment, payment gateway system 700 may a payment gateway device.

As used in this application, the terms “system” and “component” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on payment gateway system 700 and payment gateway system 700 can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Payment gateway system 700 can be a server such as a dedicated server computer, such as bladed servers, or personal computer, laptop computer, notebook computer, palm top computer, network computer, or any processor-controlled device capable of supporting the payment processing system. While FIG. 7 illustrates one payment gateway system 700 that may be a single server, it is understood that other embodiments can use multiple servers or multiple computer systems as necessary or desired to support the users and can also use back-up or redundant servers to prevent network downtime in the event of a failure of a particular server.

Payment gateway system 700 may include various computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. As shown in FIG. 7, payment gateway system 700 includes processor 702, network communication interface 704, database 706, card data validation and verification module 708, machine learning model 710 and transaction authentication module 712.

Processor 702 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein.

Network communication interface 704 is configured to establish and support wired and/or wireless data communication capability for connecting a mobile device (e.g., user device 114/412), a data store (e.g., first data store 108), a distributed ledger (e.g., public distributed ledger 408), a backend bank server (e.g., bank server 1 10/410) via a communication network (e.g., network 106/406). Network communication interface 704 can also be configured to support communication with a short-range wireless communication interface, such as Bluetooth, NFC, and so on.

Database 706 may comprise memory and can be a read-only memory, write-once read-multiple memory or read/write memory, e.g., RAM, ROM and EEPROM. The memory may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Card data validation and verification module 708 can communicate with processor 702 to obtain card data and merchant specific data. Card data may include a card number, an expiration date, a card verification value, cardholder name, and so on. The merchant specific data can include personal identification information of the user, past transactions of the user conducted with the merchant, merchant name, merchant identifier, merchant type, merchant industry, mailing address of the user, billing address of the user, bank account number of the user, and so on. Card data validation and verification module 708 may be configured to validate the card data based on the merchant specific data. For example, card data validation and verification module 708 may compare the card data with the merchant specific data to determine whether they match each other. Card data validation and verification module 708 may also be configured to verify account balance of the bank account of the user associated with card 102/402, and fund availability for completing a transaction with the merchant.

Machine learning model 710 may communicate with processor 702 to obtain the card data, the merchant specific data, the user behavior pattern data, and fraud data or profile. Machine learning model 710 is configured to perform an analysis on a current transaction being conducted using card 102 by the user with the merchant. Machine learning model 710 can receive as inputs a transaction size of the current transaction (how much the purchase costs), a frequency of the current transaction (how often the current transaction is conducted comparing with past transactions), a location of the current transaction (where the current transaction is conducted), a date and time of the current transaction (when and what time the current transaction is conducted), and a merchant type of the merchant (a service provider, a department store, a restaurant, an electronics store, and so on), and/or a known behavior pattern of the user. The known behavior pattern of the user may be stored by payment gateway system 104/404 in first data store 108 or public distributed ledger 408. The known behavior pattern of the user may include the transaction size of past transactions with the merchant, locations of the past transactions with the merchant, dates and times of the past transactions with the merchant, a frequency of the past transactions with the merchant, transaction types of the past transactions with the merchant (what type of services, goods, products, food are associated with the past transactions with the merchant), shipping addresses of the past transactions with the merchant, billing addresses of the past transactions with the merchant, email addresses of the past transactions with the merchant, phone numbers of the past transactions with the merchant, and/or fraud history associated with the user or the past transactions with the merchant.

Payment gateway system 104 can determine whether the current transaction is a fraud transaction based on the machine learning model analysis. For example, machine learning model 710 may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

Transaction authentication module 712 can communicate with processor 702 to authenticate the user and approve the current transaction based on card data validation and verification module 708 and/or the analysis result of machine learning model 710. Transaction authentication module 712 can authenticate the user based on the retrieved user data and/or received card data. For example, the user can be authenticated based on the login credentials of the user for the merchant account. The user can also be authenticated based on the card number, billing address and/or phone number of the user.

Transaction authentication module 712 may send a challenge to perform multifactor authentication to user device 114/412. This may include the user receiving a one-time passcode (OTP) from transaction authentication module 712 via user device 114/412. This may also include tapping their contactless card to user device 114/412 to send encrypted data to transaction authentication module 712 or bank server 110 as described herein. The contactless card may be card 102/402 or another card. Multi-factor authentication may also include biometric validation. The challenge may also include a security question for the user to answer. Based on the multi-factor authentication method, the user may enter the one-time passcode into a mobile bank application installed on user device 114/412, tap their contactless card, provide their biometric data, or answer the security question in the mobile bank application. Transaction authentication module 712 may receive the challenge answer and perform the validation of the challenge answer. For example, transaction authentication module 712 may compare received OTP with the stored OTP, the received security question answer to the stored security question answer, or the received biometric data to the stored biometric data to determine if they match each other. If a match is determined, the user is authenticated. If not, the current transaction may be denied and determined as a fraud transaction. In the case where the challenge answer includes encrypted data of the contactless card, transaction authentication module 712 may decrypt the encrypted data of the contactless card.

After the user is authenticated again using the multifactor authentication method, transaction authentication module 712 can approve the current transaction. The user can be provided with the purchase made for the current transaction.

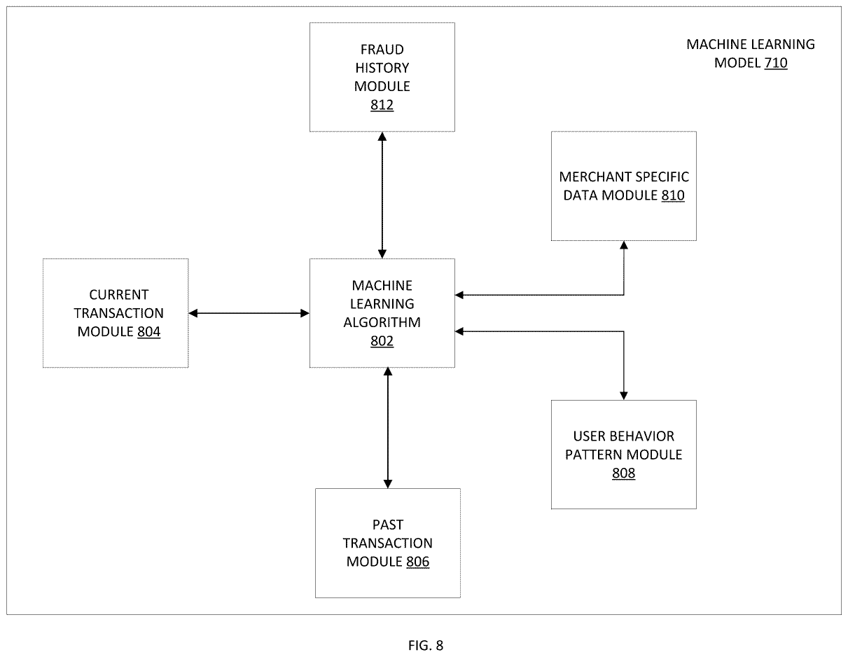

FIG. 8 illustrates a block diagram of an example machine learning model 710 configured to operate in accordance with embodiments discussed herein. Machine learning model 710 may include machine learning algorithm 802. Machine learning algorithm 802 may include a communication interface as well as an algorithm processor coupled to a plurality of modules including current transaction module 804, past transaction module 806, user behavior pattern 808, merchant specific data module 810, and fraud history module 812.

Current transaction module 804 can receive data of a current transaction conducted by the user with the merchant. The data of a current transaction can include a location of the current transaction, a date of the current transaction, a time of the current transaction, a billing address of the current transaction, a mailing address of the current transaction, a user name of the current transaction, an amount of the current transaction, a product or service item list of the current transaction, a card number of a card used for the current transaction, a card expiration date of the card used for the current transaction, a cardholder name of the card used for the current transaction, a CVV of the card used for the current transaction.

Past transaction module 806 can receive data of past transactions of the user conducted with the merchant. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions.

User behavior pattern module 808 can obtain data of user behavior pattern of the user associated with the merchant. The data of user behavior pattern can include a shopping frequency of the user, shopping locations of the user, shopping dates and times of the user, shopping websites of the user, shopping sections on a website of the user, products and/or services the user regularly purchases, a purchase amount of the user on a regular basis, cards the user regularly uses for purchases, shipping addresses the user regularly uses, billing addresses the user regularly uses, and a ratio of online purchases versus in-store purchases with the merchant.

Merchant specific data module 810 can receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., card 102 or user device 114) of the user and payment gateway system of the merchant.

Fraud history module 812 may also refer to a fraud profile module. Fraud history module 812 can receive, store and process fraud-related data of the user and/or the merchant. The fraud-related data can include fraud history of the user, a type of the fraud, date and time when the fraud occurs, a location where the fraud happens, which card involved in the fraud, what measures the merchant takes for the fraud, a fund amount involved in the fraud, and a frequency of fraud happening with the user and/or the merchant.

Each of current transaction module 802, past transaction module 806, user behavior pattern module 808, merchant specific data module 810, and fraud history module 812 can provide corresponding data to machine learning algorithm 802. In turn, machine learning algorithm 802 may make predictions regarding whether a current transaction is fraudulent, what the user will purchase next time, when the user will make a next purchase with the merchant, how often the user will conduct transactions with the merchant, which card the user will use for a next transaction, and so on. In an embodiment, the machine learning algorithms employed can include at least one selected from the group of gradient boosting machine, logistic regression, neural networks, and a combination thereof, however, it is understood that other machine learning algorithms can be utilized.

Machine learning model 710 described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Machine learning model 710 described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real valued weight. Nodes may either be (i) input nodes (e.g., receiving data from outside the network), (ii) output nodes (e.g., yielding results), or (iii) hidden nodes (e.g., that may modify the data enroute from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, machine learning model 710 described herein may be trained prior to use and the training may continue with updated data sets that reflect additional information.

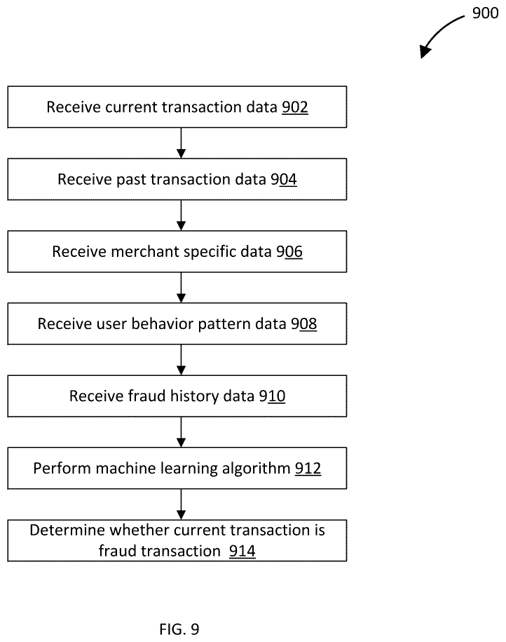

FIG. 9 illustrates a flow chart of an example method 900 for machine learning analysis of decentralized payment processing in accordance with embodiments discussed herein. Method 900 may be performed by machine learning model 710, and include the following steps.

At block 902, current transaction module 804 may receive current transaction data. The current transaction data may include a transaction amount of the current transaction, a location of the current transaction, a date and time of the current transaction, a product or service item list of the current transaction, a card number for the current transaction, a shipping address for the current transaction, a billing address for the current transaction, and so forth.

At block 904, past transaction module 806 may receive past transaction data associated with the user and the merchant. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions.

At block 906, merchant specific data module 810 can receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., card 102 or user device 114) of the user and payment gateway system of the merchant.

At block 908, user behavior pattern module 808 can obtain data of user behavior pattern of the user associated with the merchant. The data of user behavior pattern can include a shopping frequency of the user, shopping locations of the user, shopping dates and times of the user, shopping websites of the user, shopping sections on a website of the user, products and/or services the user regularly purchases, a purchase amount of the user on a regular basis, cards the user regularly uses for purchases, shipping addresses the user regularly uses, billing addresses the user regularly uses, and a ratio of online purchases versus in-store purchases with the merchant.

At block 910, fraud history module 812 may receive, store and process fraud-related data of the user and/or the merchant. The fraud-related data can include fraud history of the user, a type of the fraud, date and time when the fraud occurs, a location where the fraud happens, which card involved in the fraud, what measures the merchant takes for the fraud, a fund amount involved in the fraud, and a frequency of fraud happening with the user and/or the merchant.

At block 912, each of current transaction module 802, past transaction module 806, user behavior pattern module 808, merchant specific data module 810, and fraud history module 812 can provide corresponding data to machine learning algorithm 802. In turn, machine learning algorithm 802 may make predictions regarding whether a current transaction is fraudulent, what the user will purchase next time, when the user will make a next purchase with the merchant, how often the user will conduct transactions with the merchant, which card the user will use for a next transaction, and so on. In this example, machine learning algorithm 802 is performed to analyze the inputted data and predict whether the current transaction is a fraudulent transaction. Machine learning algorithm 802 employed can include at least one selected from the group of gradient boosting machine, logistic regression, neural networks, and a combination thereof, however, it is understood that other machine learning algorithms can be utilized.

At block 914, machine learning algorithm 802 determines whether the current transaction is a fraudulent transaction. For example, machine learning algorithm 802 may compare the above information of the current transaction with the known behavior pattern of the user to determine if the above information of the current transaction complies with the known behavior pattern of the user. If the above information of the current transaction complies with the known behavior pattern of the user, the current transaction may be determined as a legitimate transaction; if the above information of the current transaction does not comply with the known behavior pattern of the user or the above information of the current transaction raises a fraud flag, the current transaction may be determined as a fraud transaction.

The present disclosure may provide a payment gateway device. The payment gateway device can include a processor, and a memory storing computer-executable instructions. When computer-executable instructions are executed by the processor, the computer-executable instructions can cause the processor to: receive, from a server, merchant specific data associated with a user; validate card data of a card of the user based on the merchant specific data; perform, using a machine learning model, an analysis on a transaction being conducted using the card by the user with a merchant associated with the payment gateway device, the analysis including comparing a transaction size of the transaction, a frequency of the transaction, a location of the transaction, a time of the transaction, and a merchant type of the merchant, against a known behavior pattern of the user; determine, based on the analysis, whether the transaction is a fraud transaction; in responsive to a determination that the transaction is a legitimate transaction, verify an account balance and fund availability of the card; and approve the transaction.

In some embodiment, the processor is further configured to authenticate the user based on the card of the user or login credentials of the user. The merchant specific data includes at least one selected from the group of personal identification information of the user, past transactions of the user conducted with the merchant, and the card data of the user.

In some embodiments, the user is a recurring customer of the merchant. The known behavior pattern of the user is generated by the merchant based on past transactions conducted by the user with the merchant.

In some embodiments, the machine learning model is trained using the merchant specific data of the user and the known behavior pattern of the user. The machine learning model is configured to predict further transaction information of the user.

In some embodiments, the further transaction information of the user includes a time of a future transaction, a location of the future transaction, or a size of the future transaction.

In some embodiments, the instructions can further cause the processor to transmit an alert message to a user device of the user requesting an additional verification for the transaction. The alert message is transmitted to the user device before completing the transaction.

In some embodiments, the payment gateway device can include at least one application programming interface (API) configured to receive from the server the merchant specific data associated with the user.

The present disclose may also provide a non-transitory computer-readable medium having computer-executable instructions stored thereon that, when executed by a payment gateway device, cause the payment gateway device to: receive, from a server, merchant specific data associated with a user; validate card data of a card of the user based on the merchant specific data; perform, using a machine learning model, an analysis on a transaction being conducted using the card by the user with a merchant associated with the payment gateway device; determine, based on the analysis, whether the transaction is a fraud transaction; verify an account balance and fund availability of the card; and approve the transaction.

In some embodiments, the analysis includes comparing at least one selected from the group of a transaction size of the transaction, a frequency of the transaction, a location of the transaction, a time of the transaction, and a merchant type of the merchant, against a known behavior pattern of the user.

In some embodiments, the instructions can further cause the payment gateway device to authenticate the user before approving the transaction.

In some embodiments, the merchant specific data and the known behavior pattern of the user are stored in a distributed ledger.

In some embodiments, the card comprises a unique identifier identifying the card, the user, and/or an account associated with the card.

The present disclosure also provides a payment processing method. The payment processing method can include receiving, by a payment gateway from a server, merchant specific data associated with a user; validating, by the payment gateway, card data of a card of the user based on the merchant specific data; performing, by the payment gateway using a machine learning model, an analysis on a transaction being conducted using the card by the user with the merchant; determining, by the payment gateway based on the analysis, whether the transaction is a fraud transaction; verifying, by the payment gateway, an account balance and fund availability of the card; and approving, by the payment gateway, the transaction.

In some embodiments, the card data includes at least one selected from the group of a card number, an expiration date, and a card verification value. In some embodiments, the machine learning model is configured to predict one or more items the user is going to purchase. In some embodiments, the analysis includes comparing a transaction size of the transaction, a frequency of the transaction, a location of the transaction, a time of the transaction, and a merchant type of the merchant, against a known behavior pattern of the user.

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-9 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, the term “merchant” is not limited to a particular merchant or type of merchant. Rather, the term includes any type of merchant, vendor, or other entity involving in activities where products or services are sold or otherwise provided.

As used herein, the term “bank” is not limited to a financial institution or other type of entity. Rather, the term includes any type of financial institution, business or industrial organization, or other entity involved in the handling or processing of transactions.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A payment gateway device, comprising:
a processor; and
a memory storing computer-executable instructions that, when executed by the processor, cause the processor to:
receive, from a server, merchant specific data associated with a user;
validate card data of a card of the user based on the merchant specific data;
perform, using a machine learning model, an analysis on a transaction being conducted using the card by the user with a merchant associated with the payment gateway device, the analysis including comparing a transaction size of the transaction, a frequency of the transaction, a location of the transaction, a time of the transaction, and a merchant type of the merchant, against a known behavior pattern of the user;
determine, based on the analysis, whether the transaction is a fraud transaction;
in responsive to a determination that the transaction is a legitimate transaction, verify an account balance and fund availability of the card; and
approve the transaction.

2. The payment gateway device of claim 1, wherein the processor is further configured to authenticate the user based on the card of the user or login credentials of the user.

3. The payment gateway device of claim 1, wherein the merchant specific data includes at least one selected from the group of personal identification information of the user, past transactions of the user conducted with the merchant, and the card data of the user.

4. The payment gateway device of claim 1, wherein the user is a recurring customer of the merchant.

5. The payment gateway device of claim 1, wherein the known behavior pattern of the user is generated by the merchant based on past transactions conducted by the user with the merchant.

6. The payment gateway device of claim 1, wherein the machine learning model is trained using the merchant specific data of the user and the known behavior pattern of the user.

7. The payment gateway device of claim 1, wherein the machine learning model is configured to predict further transaction information of the user.

8. The payment gateway device of claim 7, wherein the further transaction information of the user includes a time of a future transaction, a location of the future transaction, or a size of the future transaction.

9. The payment gateway device of claim 1, wherein the instructions further cause the processor to transmit an alert message to a user device of the user requesting an additional verification for the transaction.

10. The payment gateway device of claim 9, wherein the alert message is transmitted to the user device before completing the transaction.

11. The payment gateway device of claim 1, further comprising at least one application programming interface (API) configured to receive from the server the merchant specific data associated with the user.

12. A non-transitory computer-readable medium having computer-executable instructions stored thereon that, when executed by a payment gateway device, cause the payment gateway device to:
receive, from a server, merchant specific data associated with a user;
validate card data of a card of the user based on the merchant specific data;
perform, using a machine learning model, an analysis on a transaction being conducted using the card by the user with a merchant associated with the payment gateway device;
determine, based on the analysis, whether the transaction is a fraud transaction;
verify an account balance and fund availability of the card; and
approve the transaction.

13. The non-transitory computer-readable medium of claim 12, wherein the analysis includes comparing at least one selected from the group of a transaction size of the transaction, a frequency of the transaction, a location of the transaction, a time of the transaction, and a merchant type of the merchant, against a known behavior pattern of the user.

14. The non-transitory computer-readable medium of claim 12, wherein the instructions further cause the payment gateway device to authenticate the user before approving the transaction.

15. The non-transitory computer-readable medium of claim 12, wherein the merchant specific data and the known behavior pattern of the user are stored in a distributed ledger.

16. The non-transitory computer-readable medium of claim 12, wherein the card comprises a unique identifier identifying the card, the user, and/or an account associated with the card.

17. A payment processing method, comprising:
receiving, by a payment gateway from a server, merchant specific data associated with a user;
validating, by the payment gateway, card data of a card of the user based on the merchant specific data;
performing, by the payment gateway using a machine learning model, an analysis on a transaction being conducted using the card by the user with the merchant;
determining, by the payment gateway based on the analysis, whether the transaction is a fraud transaction;
verifying, by the payment gateway, an account balance and fund availability of the card; and
approving, by the payment gateway, the transaction.

18. The payment processing method of claim 17, wherein the card data includes at least one selected from the group of a card number, an expiration date, and a card verification value.

19. The payment processing method of claim 17, wherein the machine learning model is configured to predict one or more items the user is going to purchase.

20. The payment processing method of claim 17, wherein the analysis includes comparing a transaction size of the transaction, a frequency of the transaction, a location of the transaction, a time of the transaction, and a merchant type of the merchant, against a known behavior pattern of the user.
